(19) United States
(12) Patent Application Publication
(10) Pub. No.: US 2014/0156333 A1
(43) Pub. Date: Jun. 5, 2014

(54) SYSTEMS AND METHODS FOR INTERVIEW SCHEDULING

(71) Applicants: Michael Olivier, Mountain View, CA (US); Rachel Sanders, Mountain View, CA (US); Alex Vauthey, Mountain View, CA (US); Borislav Roussev, Mountain View, CA (US)

(72) Inventors: Michael Olivier, Mountain View, CA (US); Rachel Sanders, Mountain View, CA (US); Alex Vauthey, Mountain View, CA (US); Borislav Roussev, Mountain View, CA (US)

(21) Appl. No.: 13/706,129

(22) Filed: Dec. 5, 2012

(51) Int. Cl. G06Q 10/10

(52) U.S. Cl. CPC G06Q 10/1095
USPC 705/7.19

(57) ABSTRACT

A system for scheduling interviews includes an interviewer database and a calendar database. Interviewers are selected as a function of one or more modules of questions that are associated with each of the interviewers, and an interview schedule is generated for a job candidate from the selected interviewers. The system can also schedule and invite people to meetings based on their calendar availability and the skills, characteristics, or attributes associated with potential meeting attendees.

### TECHNICAL FIELD

The present disclosure generally relates to data processing systems. Specifically, the present disclosure relates to methods, systems and computer storage devices for providing a system and method to schedule interviews for job candidates and/or meetings within a business organization, systems and methods for conducting interviews of job candidates and/or meetings within a business organization, and system and methods for evaluating interviewers of job candidates and/or participants in meetings within a business organization.

### BACKGROUND

Many business organizations today, especially large corporations, struggle with the interviewing and hiring of job candidates. The interviewing and hiring processes are difficult, time consuming, non-automated, and many times do not result in the hiring of a candidate who will be a productive employee. As many a business manager or human resources person knows, a bad hire can be a real headache.

### DESCRIPTION OF THE DRAWINGS

Some embodiments are illustrated by way of example and not limitation in the FIG's. of the accompanying drawings, in which:

FIG. 1 is an example of a front end recruiter user interface;

FIG. 2 is an example of a user interface for a front end recruiter and/or a back end recruiter;

FIG. 3 is an example of a recruiter user interface that displays details about a job candidate;

FIG. 4 is an example of a recruiter user interface that permits the recruiter to provide feedback on a job candidate;

FIG. 5 is an example of a recruiter user interface illustrating job candidates and the recruiting coordinators to which the job candidates have been assigned;

FIG. 6 is an example of a recruiter user interface that is used to schedule onsite interviews for job candidates;

FIG. 7 is another example of a recruiter user interface that is used to schedule onsite interviews for job candidates;

FIG. 8 is an example of a recruiter user interface that displays an interview schedule for a job candidate and permits a recruiter or other user to select locations for the interviews;

FIG. 9 is an example of a recruiter user interface that displays details of an interview schedule for a particular job candidate;

FIG. 10 is an example of an interviewer user interface that displays specifics of an upcoming interview;

FIG. 11 is an example user interface that can be used by an interviewer during the interview of a job candidate;

FIG. 12 is another example user interface that can be used by an interviewer during the interview of a job candidate;

FIG. 13 is the user interface of FIG. 12 with interviewer comments and a rating entered into the interface;

FIG. 14 is an example user interface that can be used by members of a hiring committee during the interview process;

FIG. 15 is an example user interface for reporting ratings, feedback, and comments relating to the interview of a job candidate;

FIG. 16 is an example user interface for evaluating the feedback provided by an interviewer of a job candidate;

FIG. 17 is an example user interface that reports information and statistics for a particular interviewer;

FIG. 17A is a user interface illustrating the interviewers who are subordinate to a particular manager or other leader.

FIG. 18 is another example user interface that reports information and statistics for a particular interviewer;

FIG. 19 is an example user interface reporting new job applications by job type or job track and newly scheduled interviews by job type or job track;

FIG. 20 is a user interface reporting interview status statistics per job type or job track;

FIG. 21 is a user interface reporting on bottlenecks within the interview process;

FIG. 22 is an example of an interviewer user interface that permits an interviewer to select interview preferences;

FIGS. 23A and 23B are a flow chart of an example process to schedule interviews for job candidates;

FIGS. 24A, 24B, 24C, 24D, and 24E are diagrams illustrating features of a system and process for scheduling interviews for job candidates;

FIG. 25 is a flow chart of an example process to schedule a meeting and select people to invite to the meeting;

FIG. 26 is a flow chart of an example process to conduct an interview of a job candidate using a particular module of questions;

FIGS. 27A and 27B are a diagram illustrating features of a system and process for assisting an interviewer conducting an interview of a job candidate;

FIGS. 28A and 28B are a flow chart of an example process to determine an effectiveness of an interviewer and an effectiveness of an interview process;

FIGS. 29A and 29B are a diagram illustrating features of a system and process to determine an effectiveness of an interviewer and an effectiveness of an interview process;

FIG. 30 is a flow chart of an example process to determine an effectiveness of a meeting and an effectiveness of a meeting participant; and

FIG. 31 is a block diagram of an example embodiment of a computer system upon which an embodiment of the current disclosure can execute.

### DETAILED DESCRIPTION

The present disclosure describes methods, systems, and computer storage devices for scheduling interviews for job candidates and/or meetings. The present disclosure also describes methods, systems, and computer storage devices for conducting interviews for job candidates and meetings. The present disclosure also describes systems, methods, and computer storage devices for evaluating interviewers and meeting participants. In the following description, for purposes of explanation, numerous specific details are set forth in order to provide a thorough understanding of the various aspects of different embodiments of the present invention. It will be evident, however, to one skilled in the art, that the present invention may be practiced without all of the specific details.

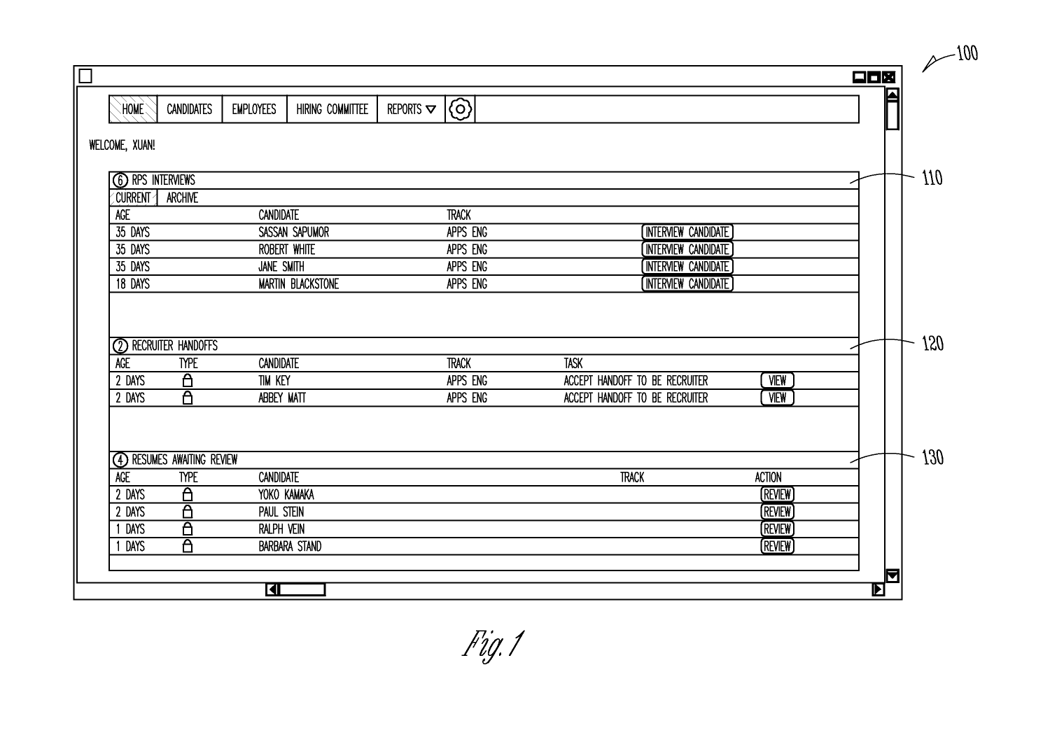

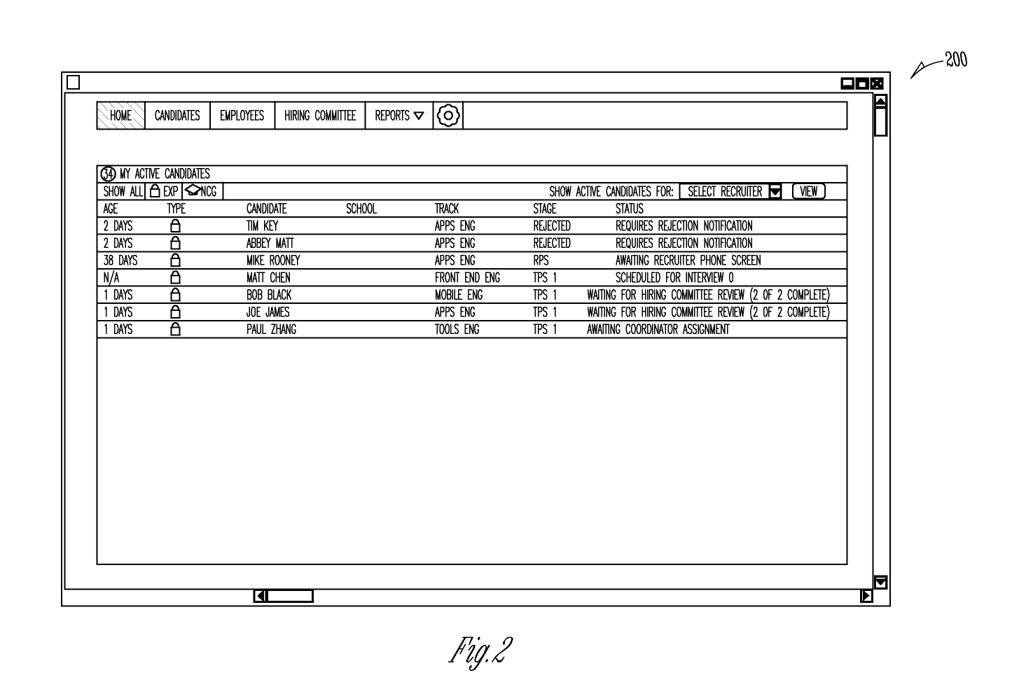

In a general embodiment, a system and process to interview job candidates begins with a front end recruiter, proceeds to a back end recruiter, and culminates with a decision as to whether or not the business organization would like to offer employment to any particular job candidate. As disclosed herein, the system and process include intelligence and user interfaces. The system and process are illustrated in FIGS. 1-31. FIGS. 1-22 illustrate many of the user interfaces, and FIGS. 23-30 illustrate flow charts and other diagrams, relating to the scheduling of job interviews or meetings, the conducting of job interviews, and the providing of feedback to interviewers and meeting participants.

Several of the figures include a number of process blocks. Though generally arranged serially in the figures, other examples may reorder the blocks, omit one or more blocks, and/or execute two or more blocks in parallel using multiple processors or a single processor organized as two or more virtual machines or sub-processors. Moreover, still other examples can implement the blocks as one or more specific interconnected hardware or integrated circuit modules with related control and data signals communicated between and through the modules. Thus, any process flow is applicable to software, firmware, hardware, and hybrid implementations. With some embodiments, some of the method operations illustrated in the figures may be performed offline by means of a batch process that is performed periodically (e.g., two times a day, daily, weekly, and so forth), while in other embodiments, the method operations may be performed online and in real-time as requests for interviewers and interview schedules are being received and processed.

FIGS. 23A and 23B illustrate at a high level a system and process 2300 to schedule an interview for one or more job candidates. At 2305, data relating to a plurality of persons is stored in a database. The persons are normally associated with the same business organization, and are qualified to interview job candidates as potential hires for the business organization. The data stored in the database associate each of the persons or interviewers in the database with one or more modules of questions that can be used in an interview of a job candidate. Each module of questions relates to one or more job types or job tracks for which a person is qualified to interview job candidates. For example, if the business organization is a software company, a person may be qualified to interview job candidates in an applications development area or a mobile services area. As a further example, in an applications development area, there may be several modules of questions such as one or more coding modules, a tech communication module, a host manager module, and a software design/architecture module. Additionally, modules may be used for interviewing in more than one area (e.g., a module may be associated with both an applications development area and a mobile services area), and an interviewer may be qualified in more than one module. The module of questions for either the application development area or mobile services area may relate to problems that require the job candidate to write software functions.

At 2310, calendar data is stored in a calendar database for each of the persons who can be a potential interviewer of job candidates. At 2315, data relating to a job candidate is entered into the computer-based system. This data can relate to information such as the education history of the job candidate, the employment history of the job candidate, and the type of job for which the business organization is considering the job candidate. At 2320, the computer system selects or allows a recruiting coordinator to select from the database one or more persons to interview the job candidate. The selection is normally based on the modules of questions that are associated with each of the persons and the job type for which the business organization is considering the job candidate. That is, a person or interviewer is normally selected to interview job candidates for particular job types, such as applications development, and there are normally one or more modules of questions that can be used in such interviews for job openings in the application development area. At 2325, the computer system generates an interview schedule for the job candidate. The generated interview schedule includes the one or more persons who were selected to interview the job candidate, time periods for each of the different interviewers, and the location(s) of the interviews. The calendar data base for each person or interviewer is also used to generate the interview schedule, so that a person is not picked to interview a job candidate during a time slot wherein that person is not available.

As noted above, an embodiment includes a front end recruiter and a back end recruiter. Normally, a front end recruiter makes an initial contact with a job candidate, for example via a telephonic or web-based interview. If the front end recruiter determines that the business organization would like to further investigate this job candidate, the front end recruiter hands the job candidate off to a back end recruiter after successful phone screen interviews by interviewers. The back end recruiter normally handles an on-site interview at the location of the business organization, and any subsequent process such as handling the job offer process. FIG. 1 illustrates a user interface 100 for a front end recruiter. The front end recruiter screen 100 is divided into three sections. Section 130 lists the job candidates for which the front end recruiter needs to review resumes. The job candidates that have attractive resumes and for which the front end recruiter would like to conduct an initial recruiter interview are listed in section 110. Section 120 lists the job candidates whom a hiring committee has decided should be granted an onsite interview, and that need to be handed off to a back end recruiter.

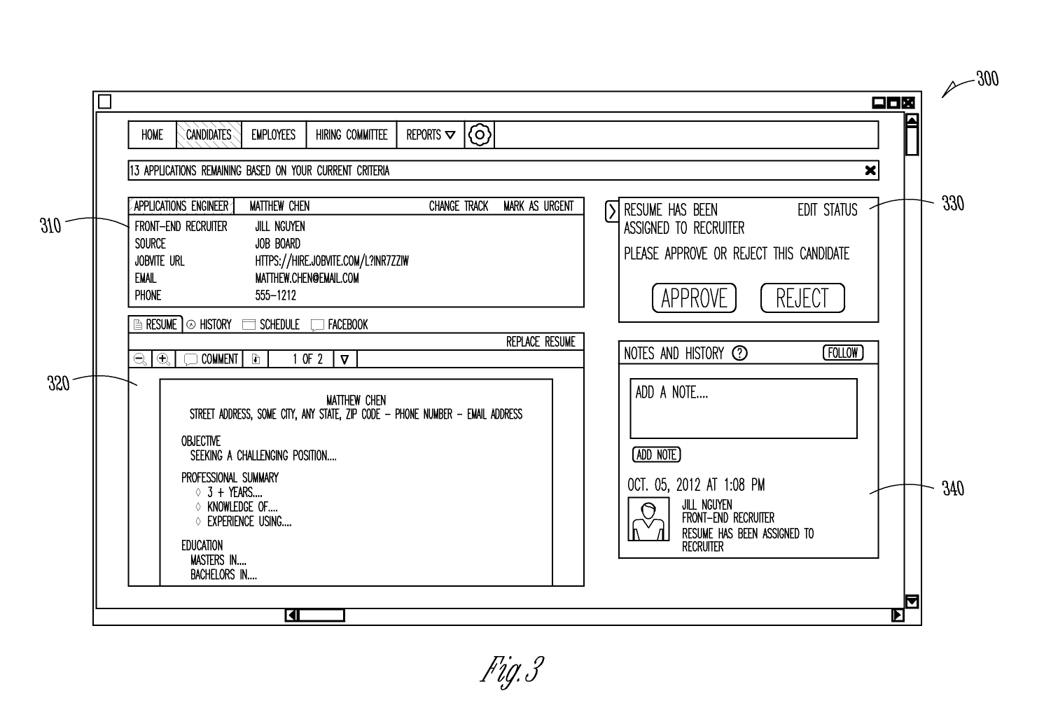

FIG. 2 illustrates an example of another user interface 200 for a front end recruiter, although the user interface 200 could also be used by a back end recruiter. The user interface 200 lists all of the job candidates for which a recruiter is responsible, the status of those job candidates, and other information associated with each of the job candidates. As can be seen from FIG. 2, the user interface 200 displays the track of each job candidate and the status of each job candidate. The track relates to the type of job for which the job candidate is being considered, such as an applications engineer, a mobile engineer, or a tools engineer. The status of a candidate, as can be seen from FIG. 2, can include that a job candidate requires rejection, a job candidate is awaiting a front end recruiter telephone screening, a job candidate is awaiting a recruiting coordinator assignment, a job candidate is waiting to be scheduled for an onsite interview, and a job candidate is waiting for a decision by the hiring committee.

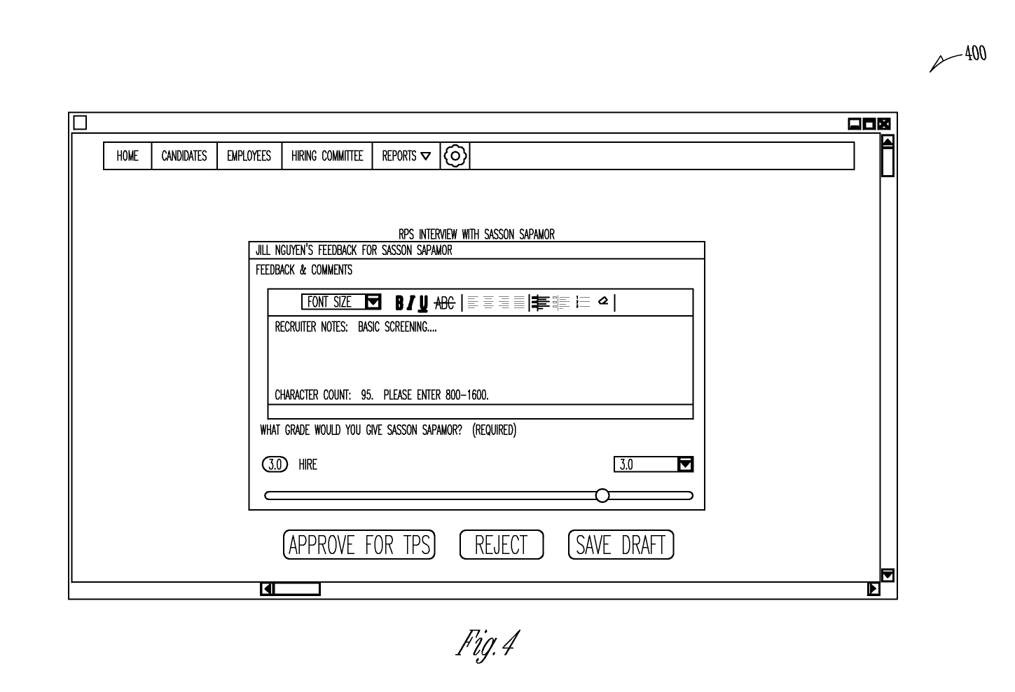

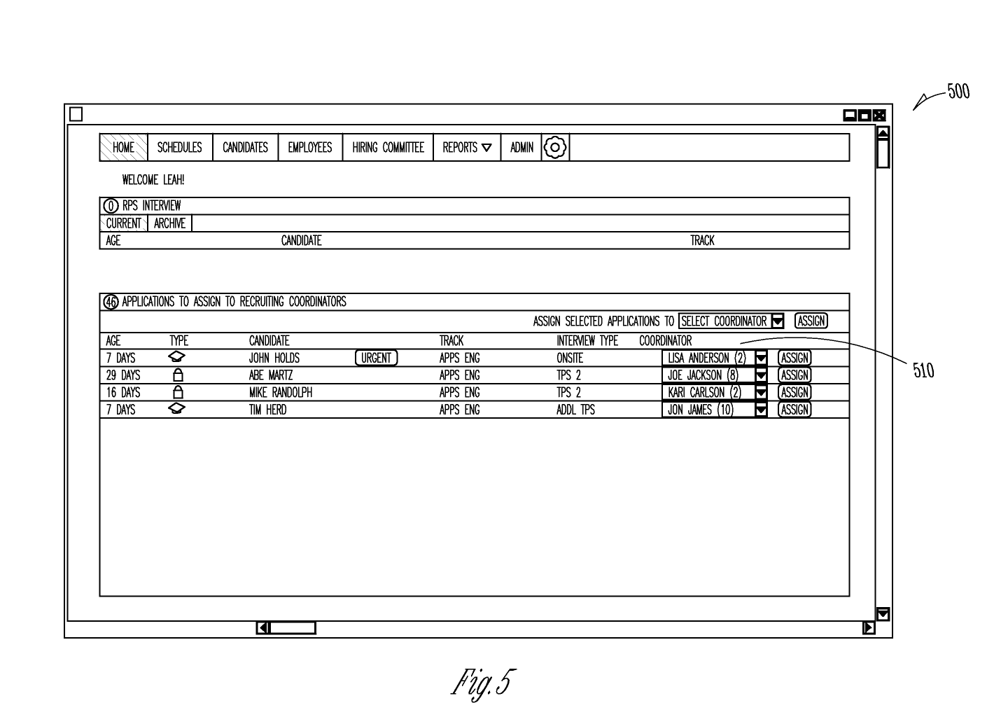

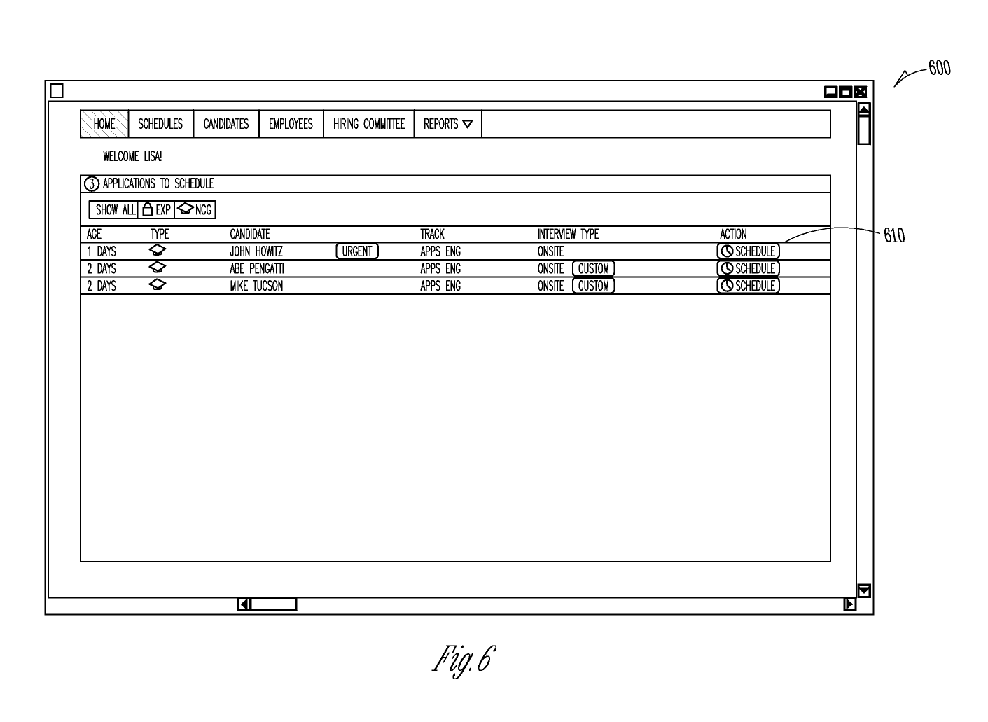

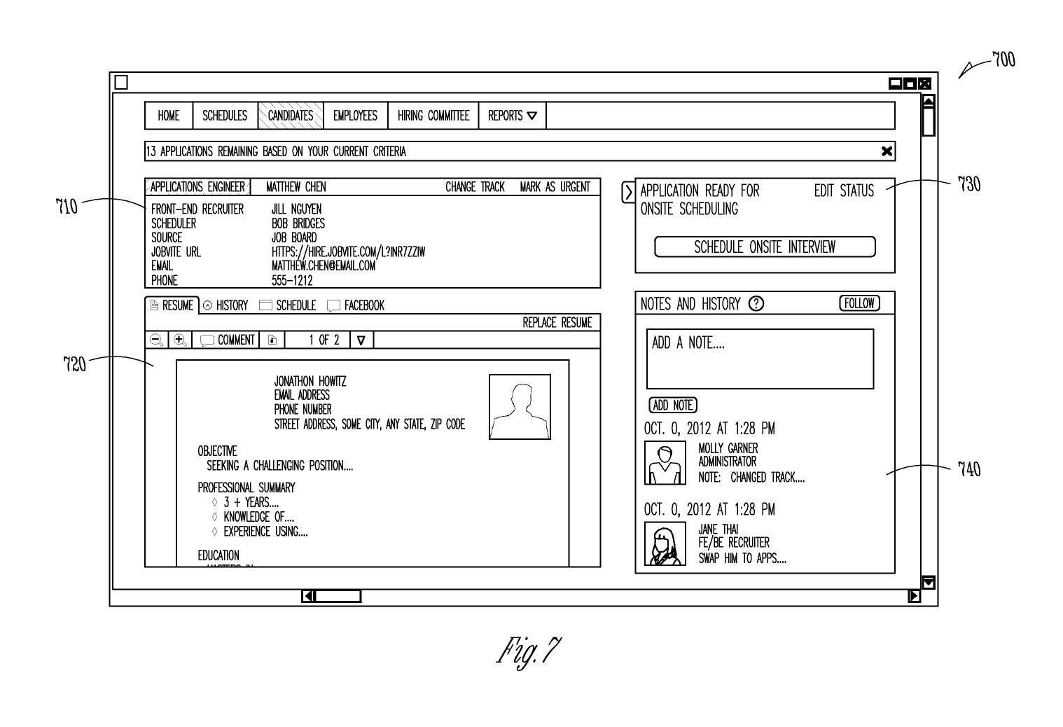

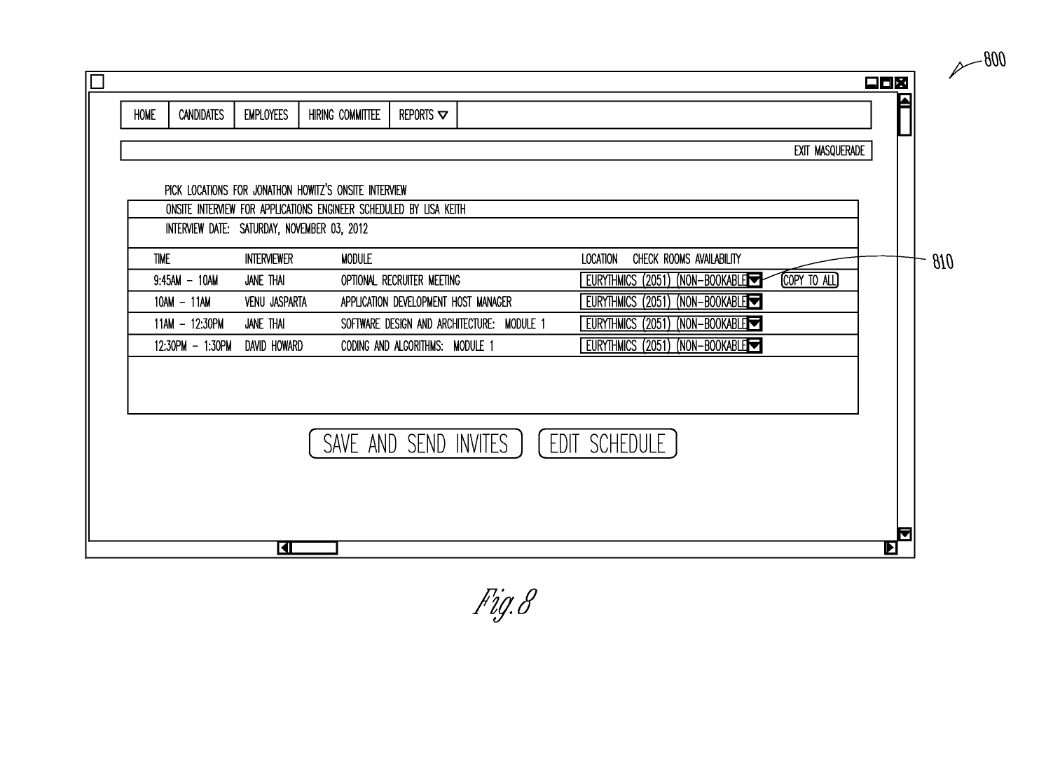

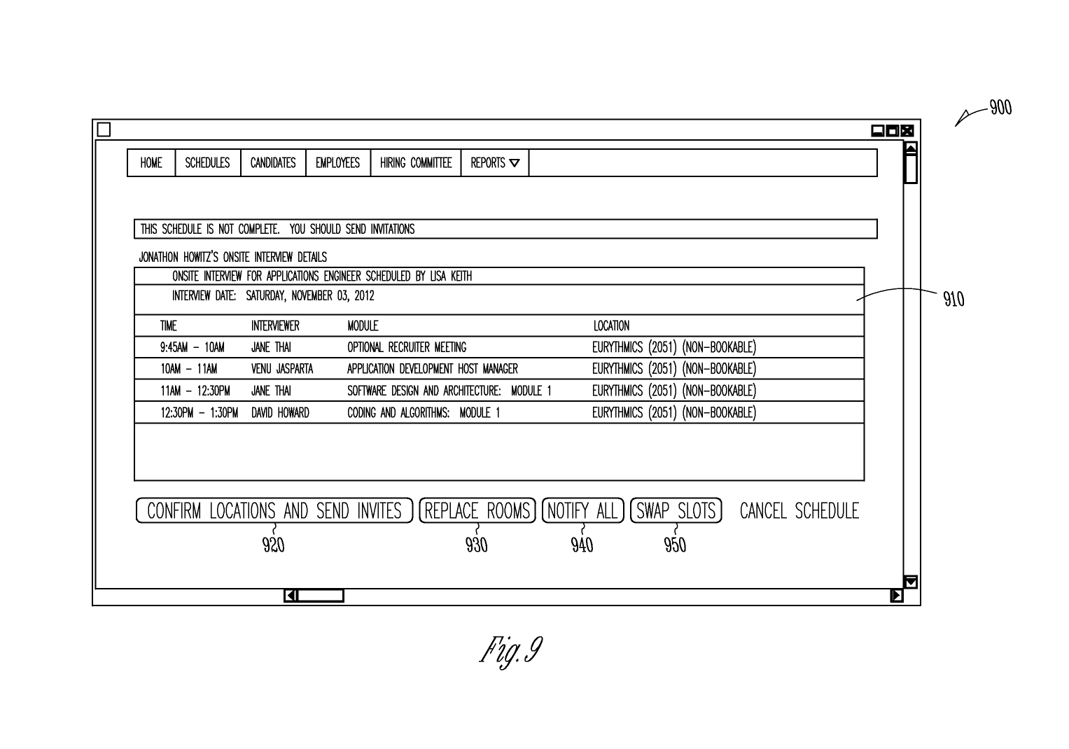

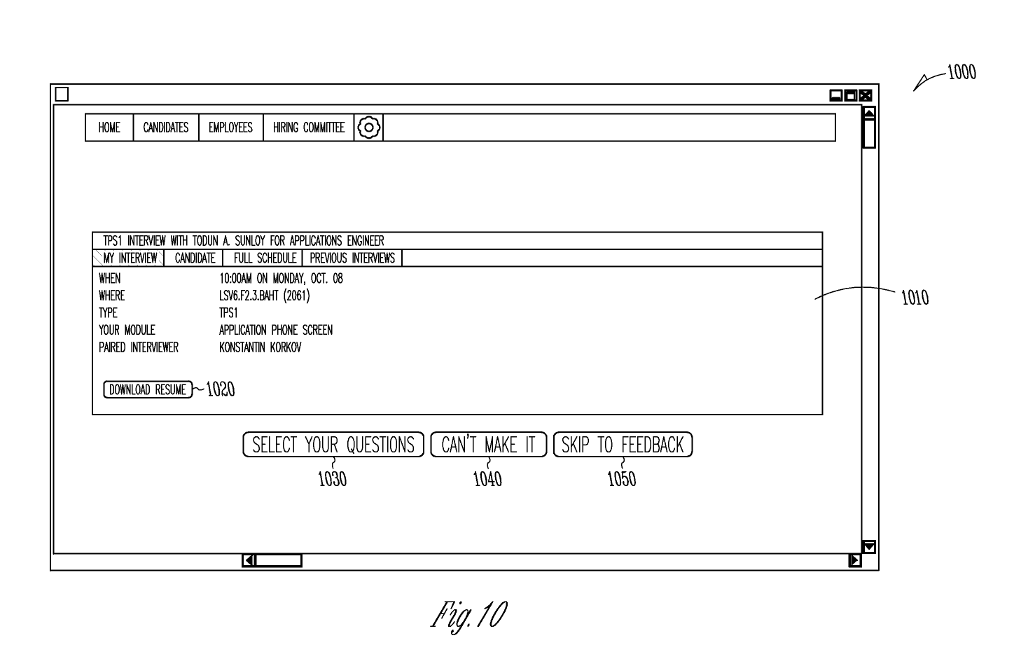

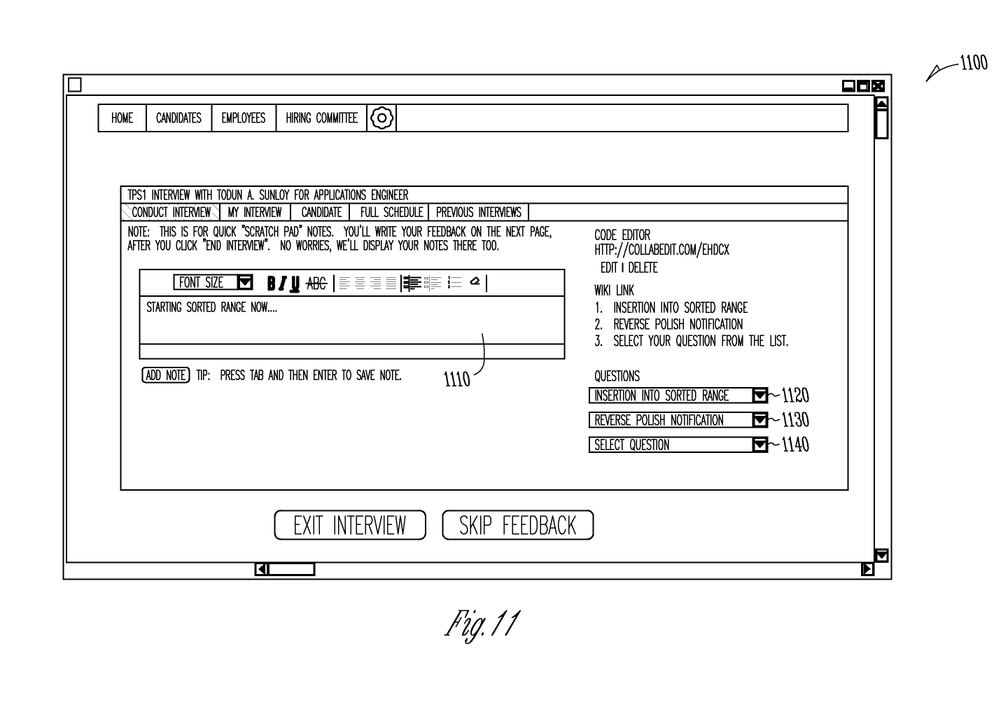

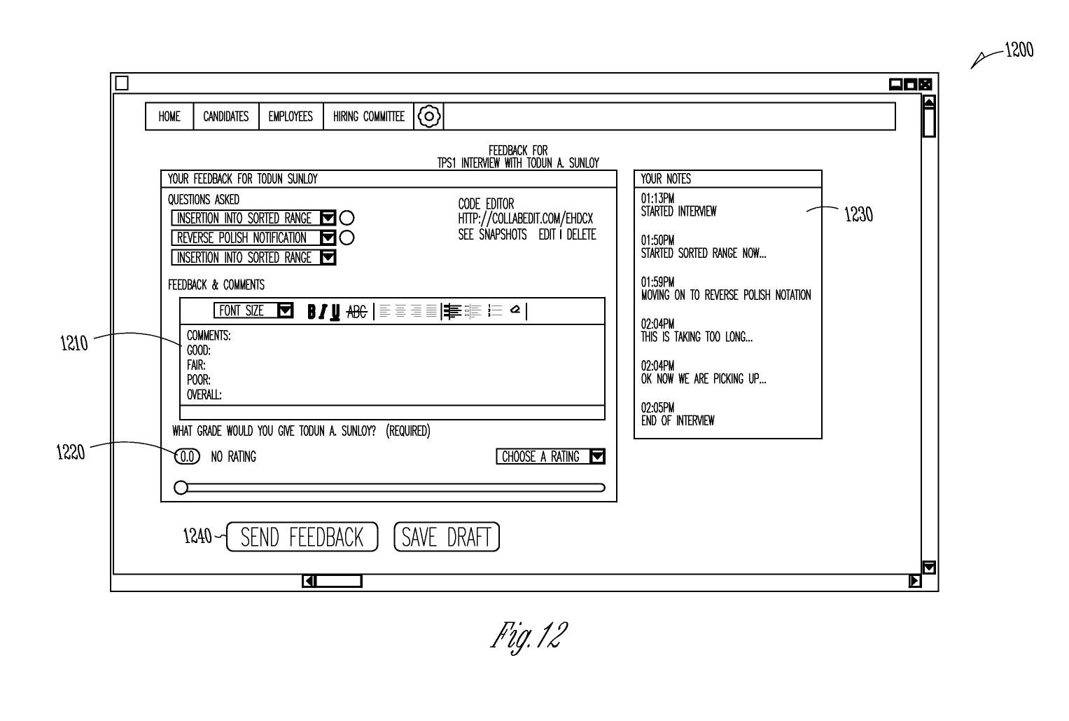

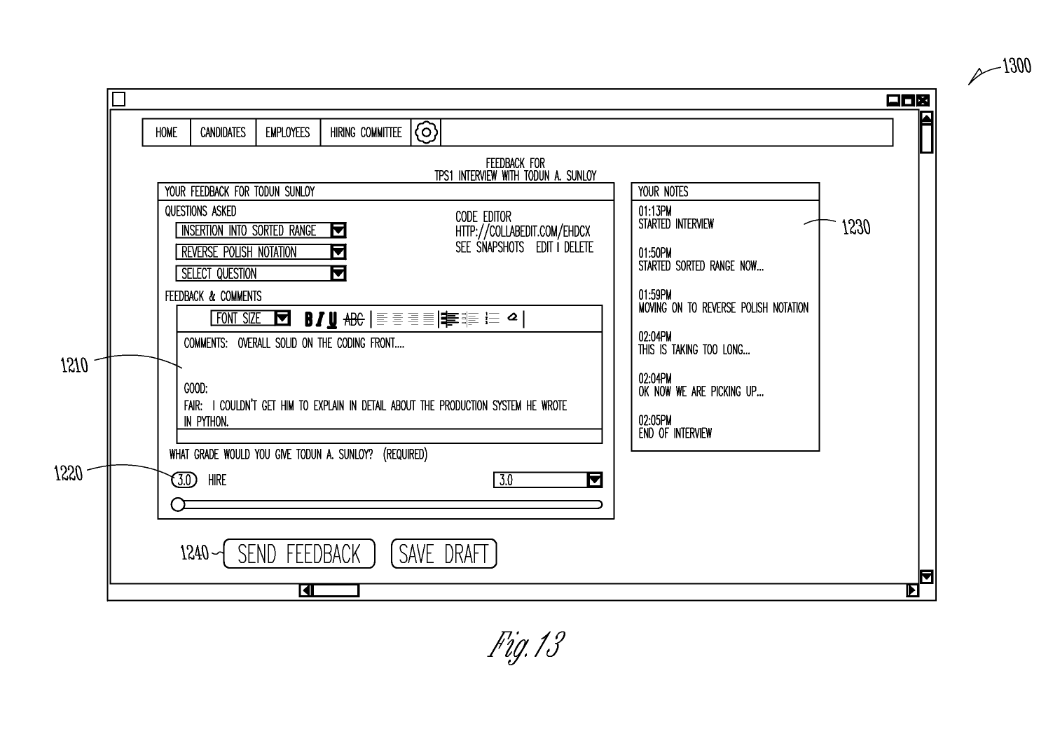

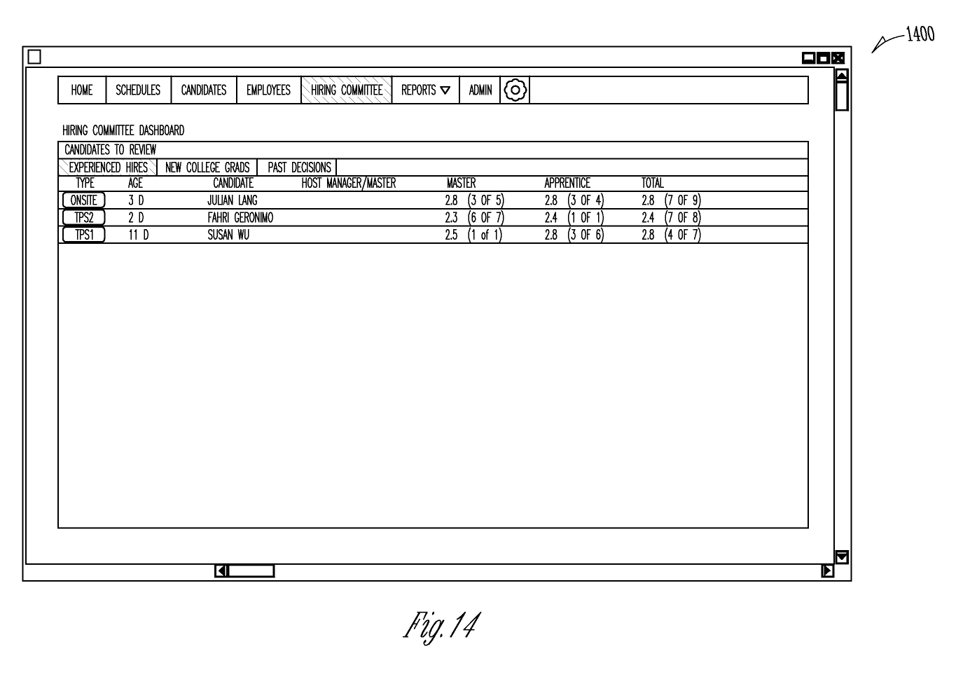

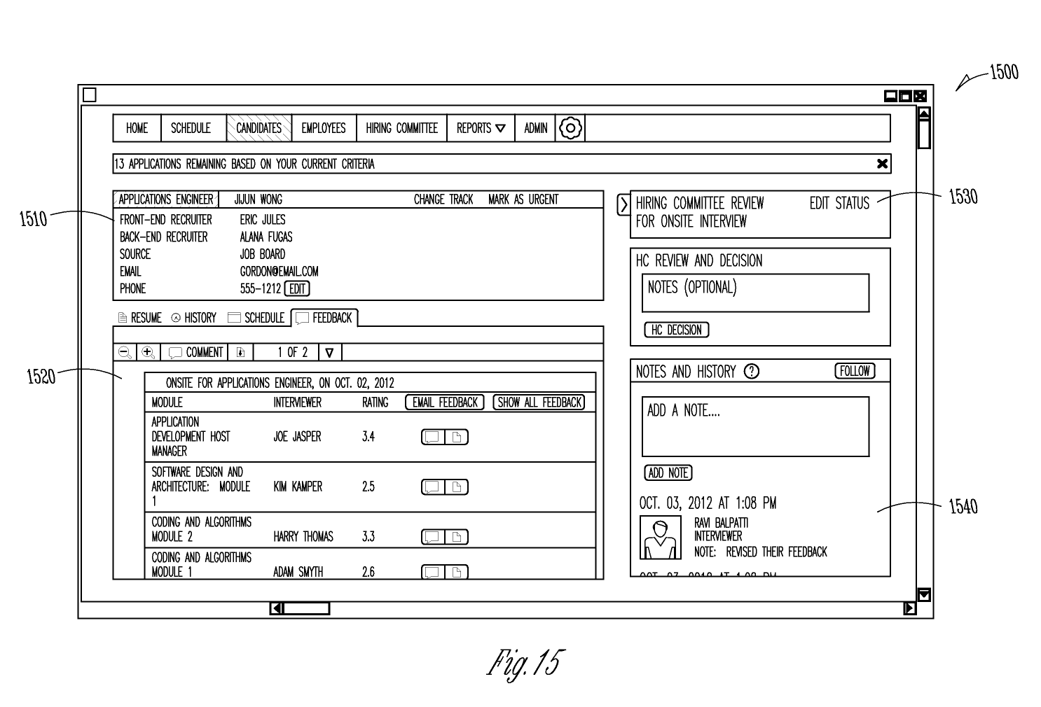

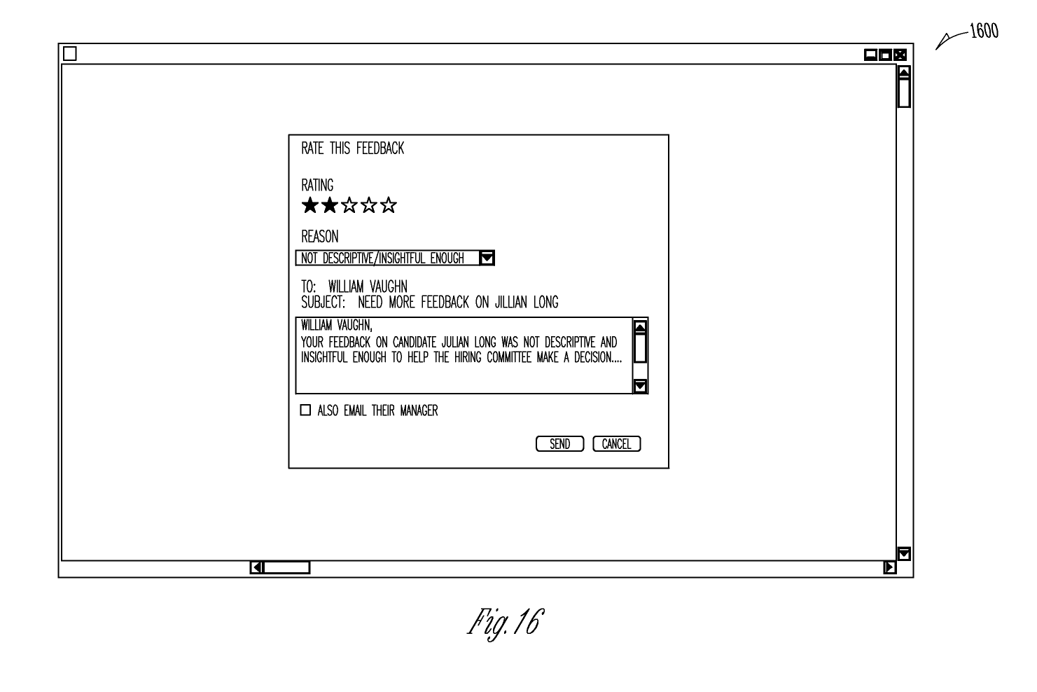

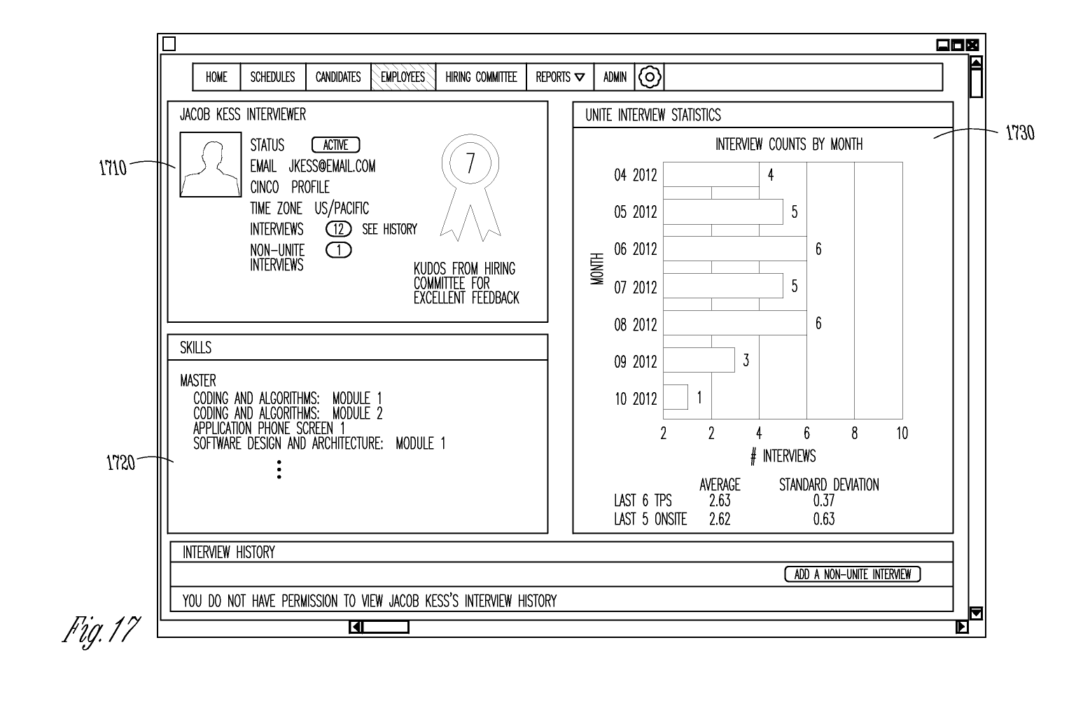

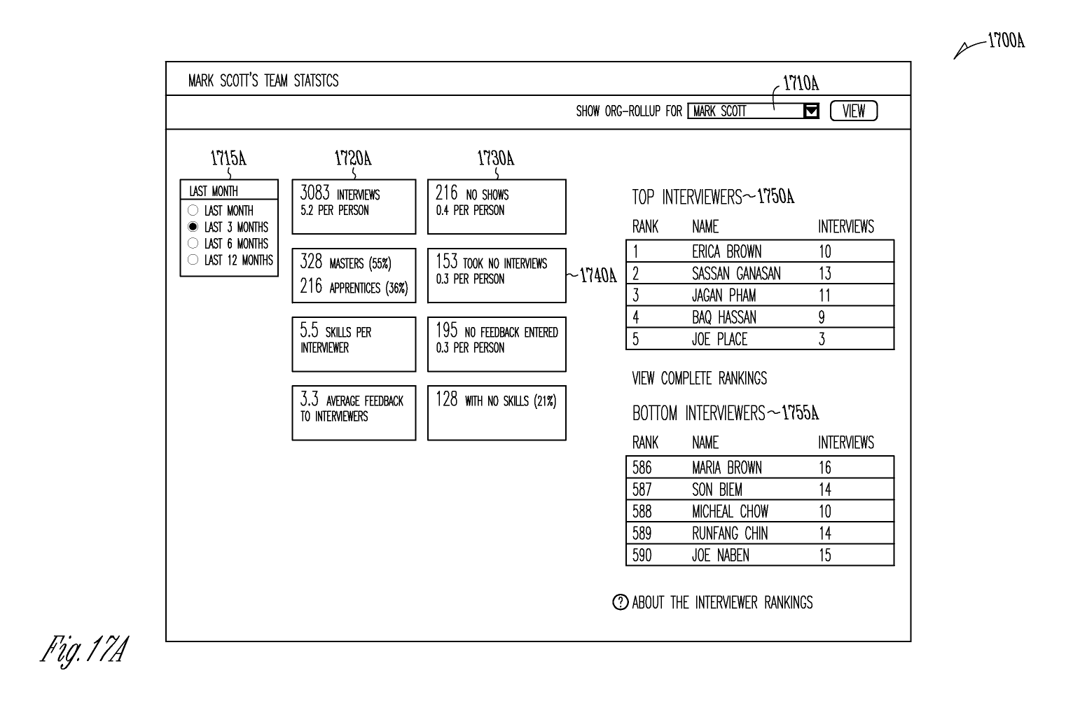

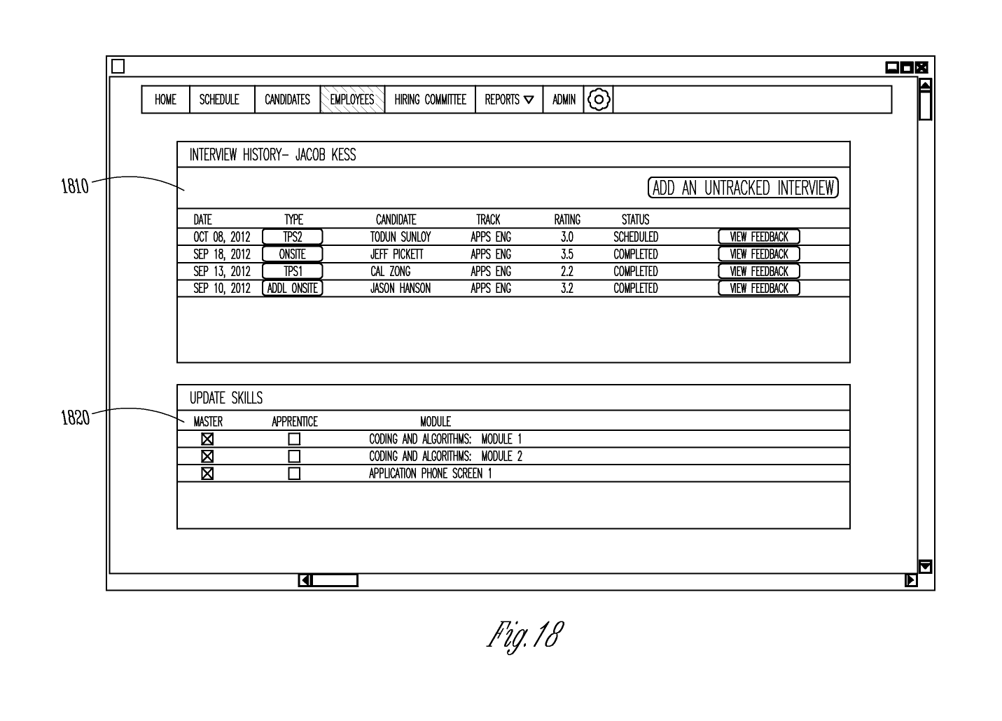

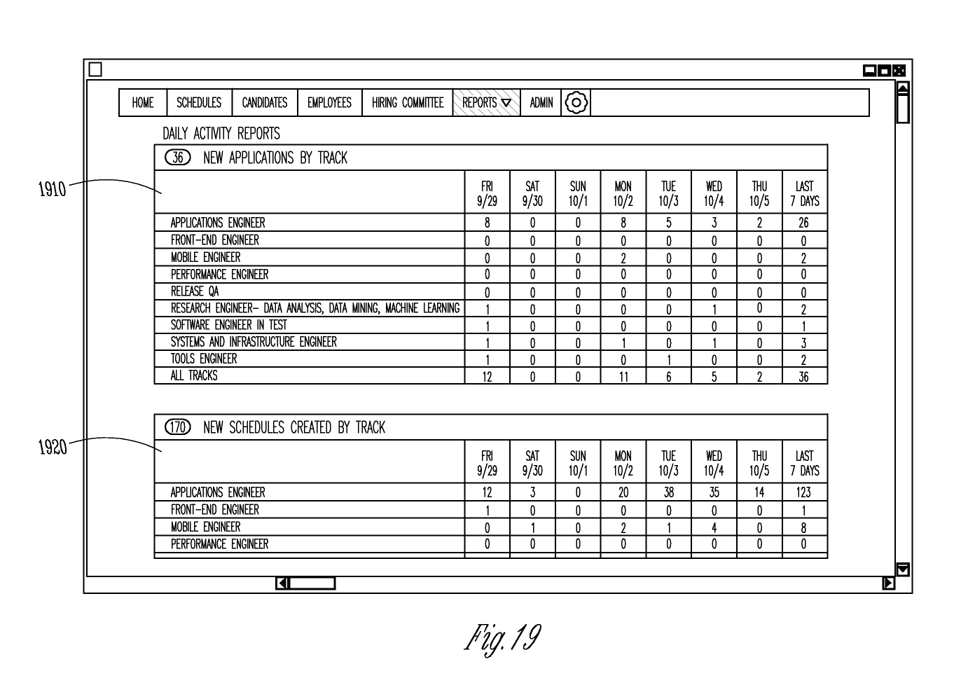

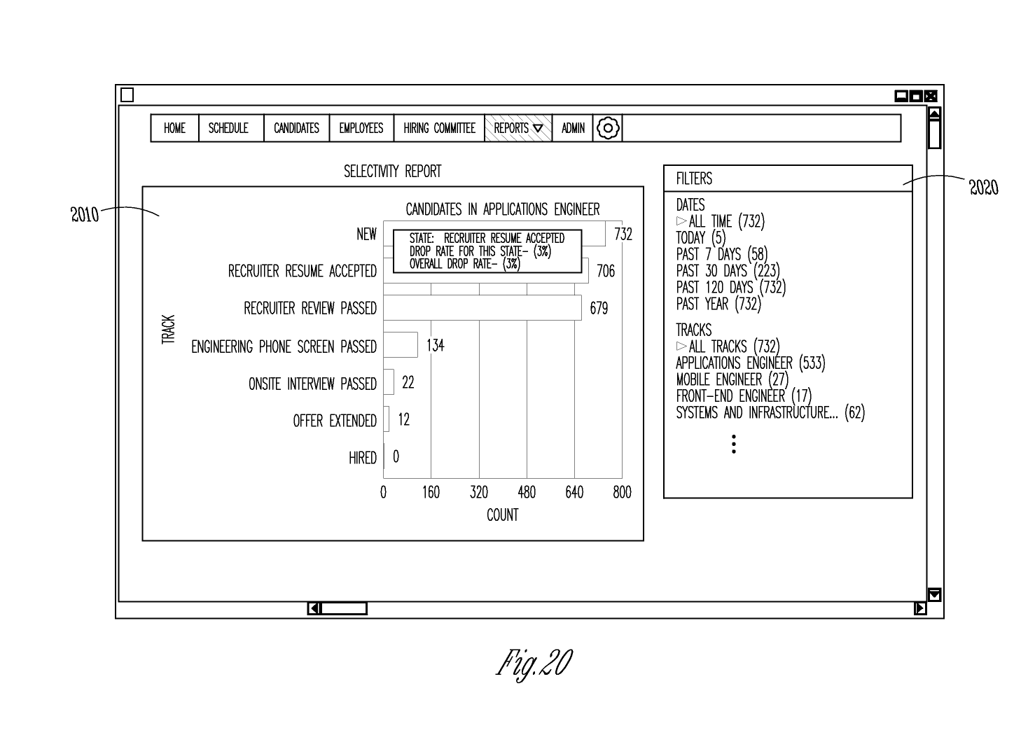

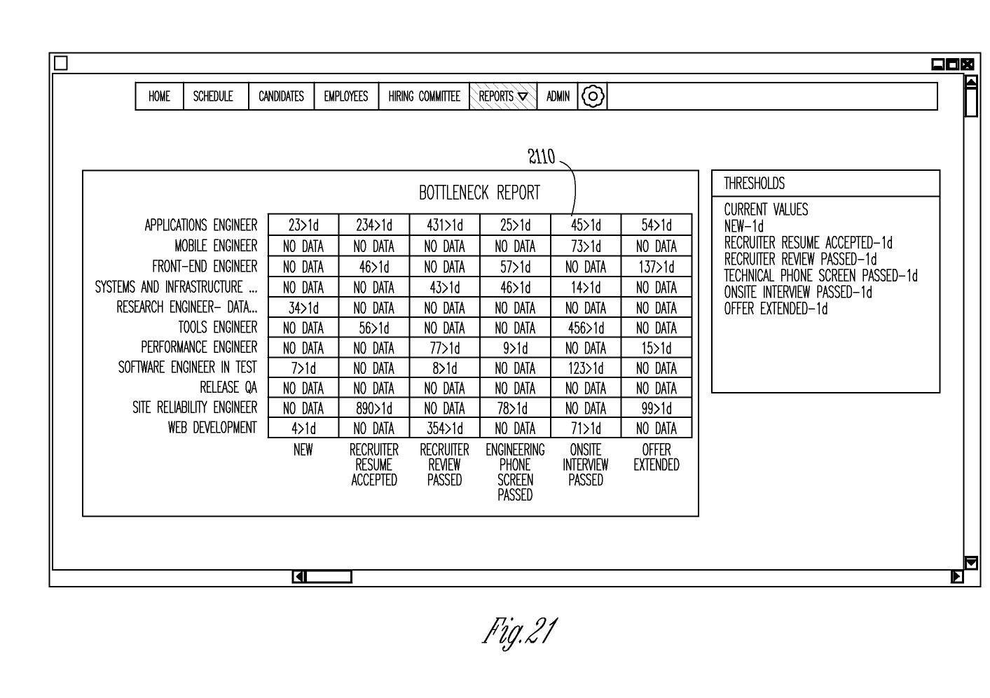

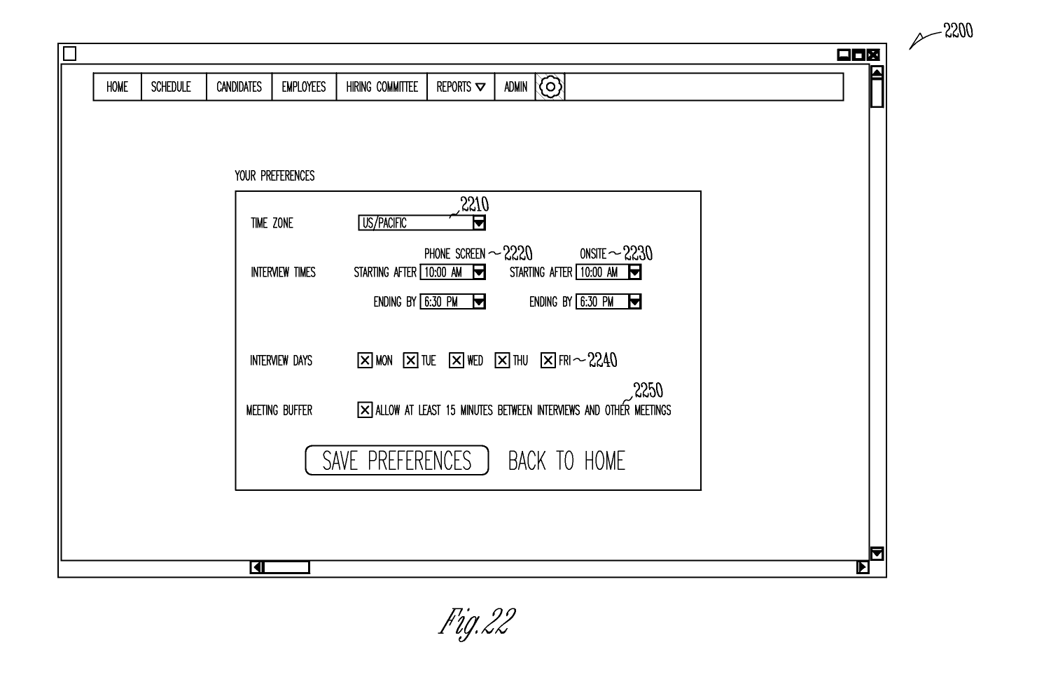

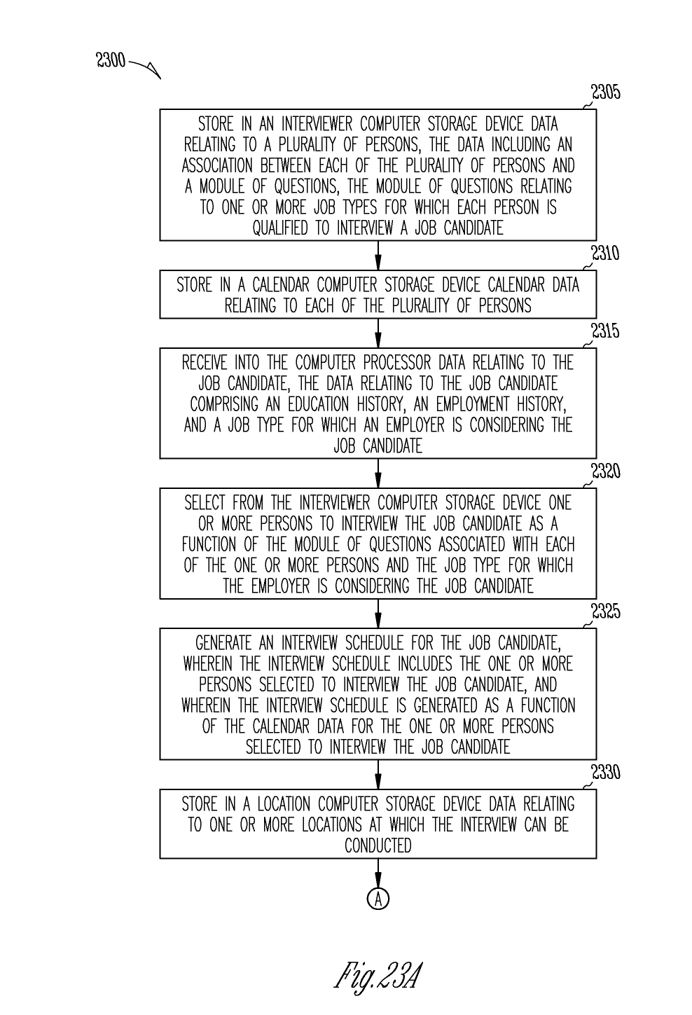

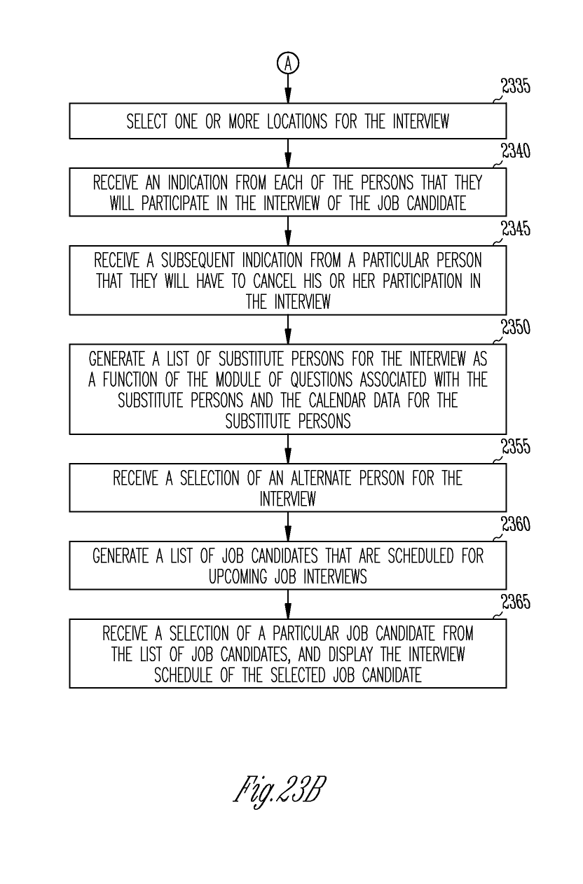

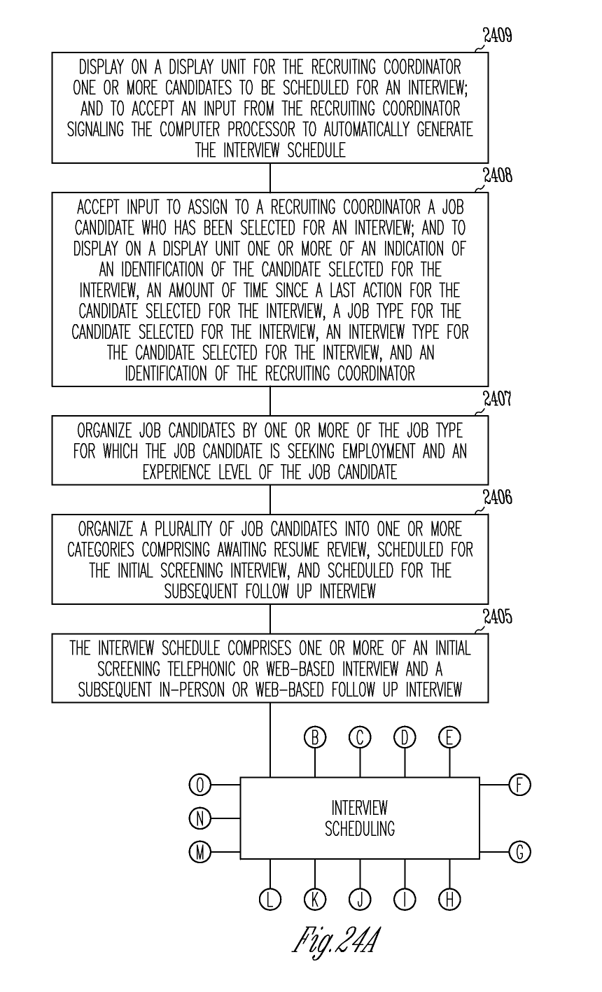

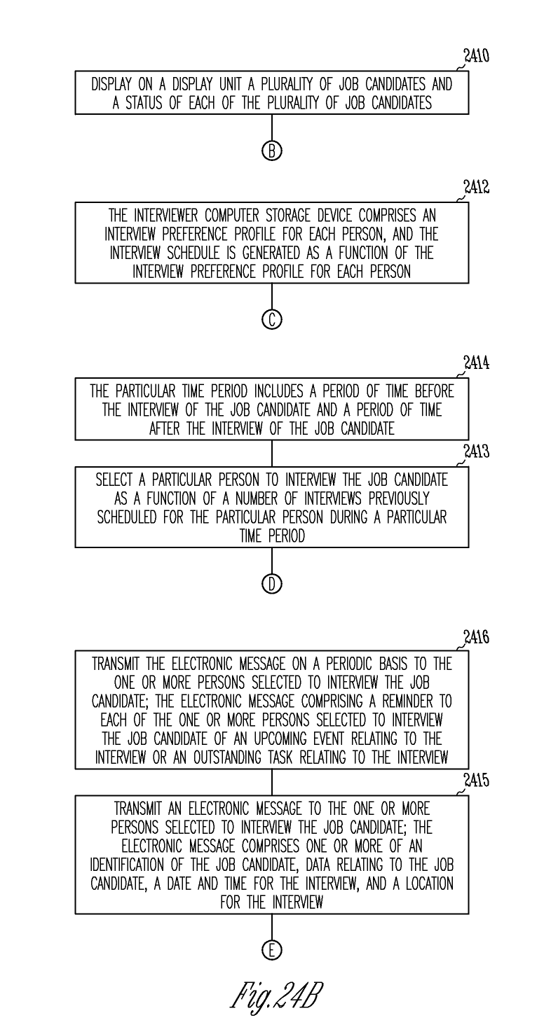

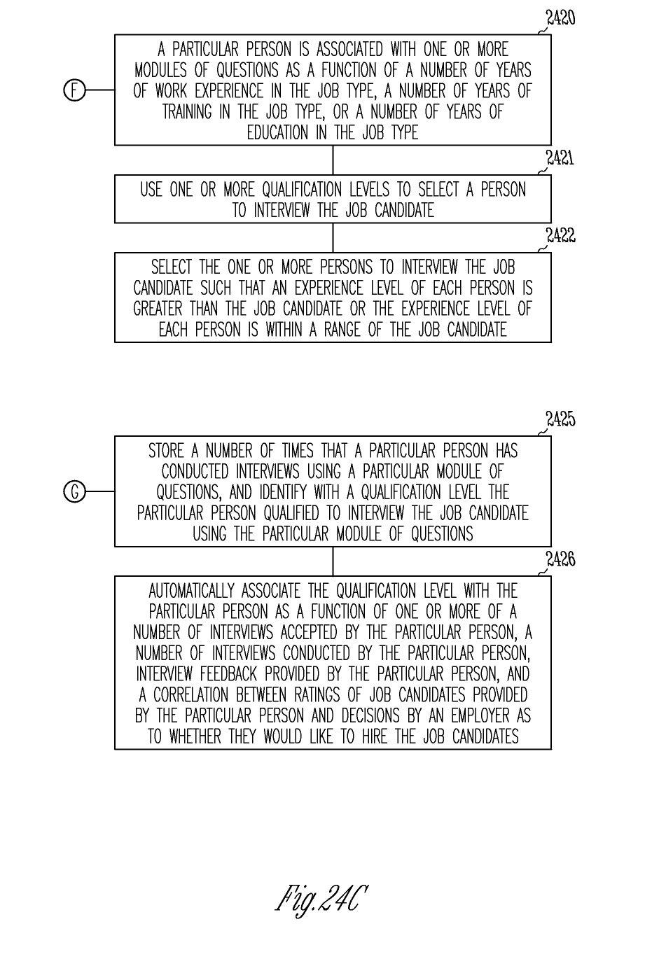

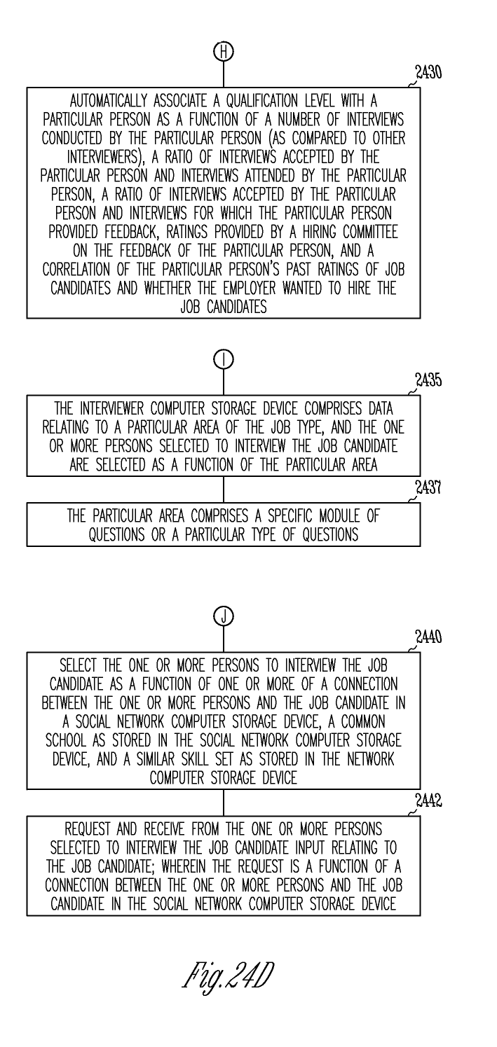

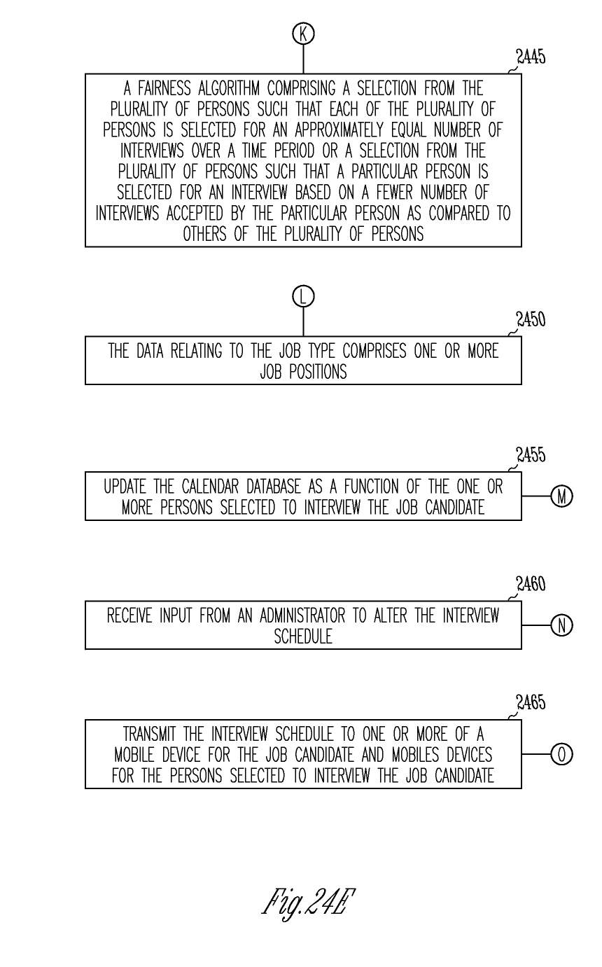

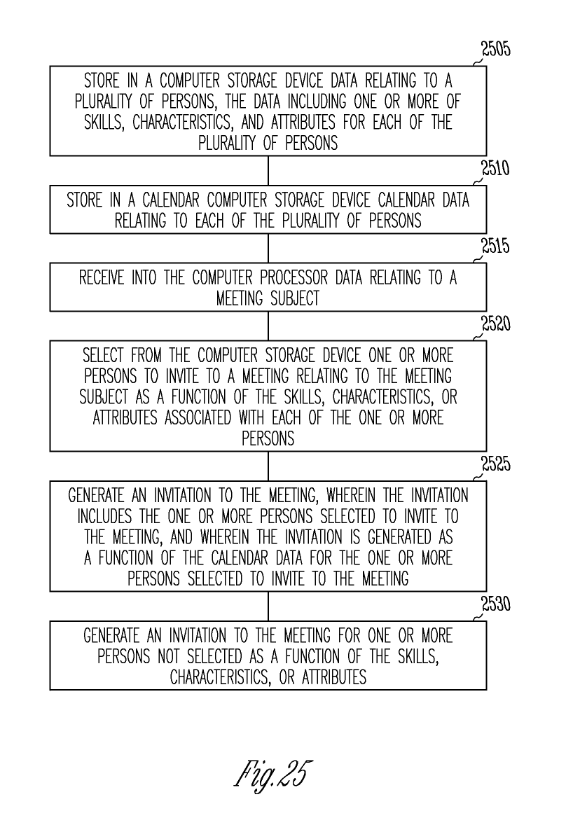

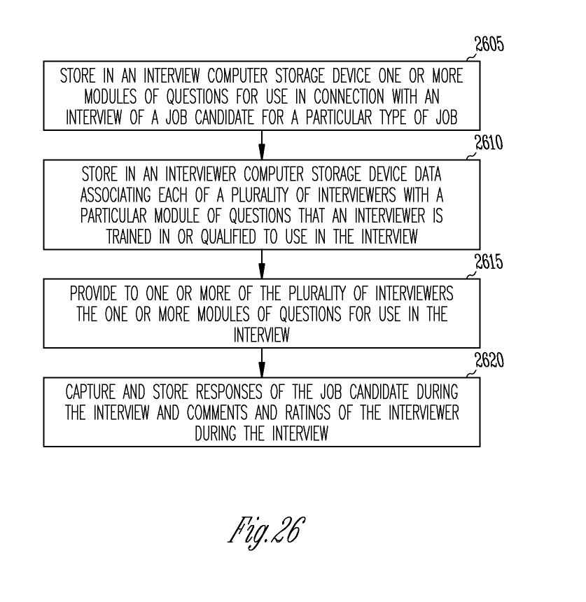

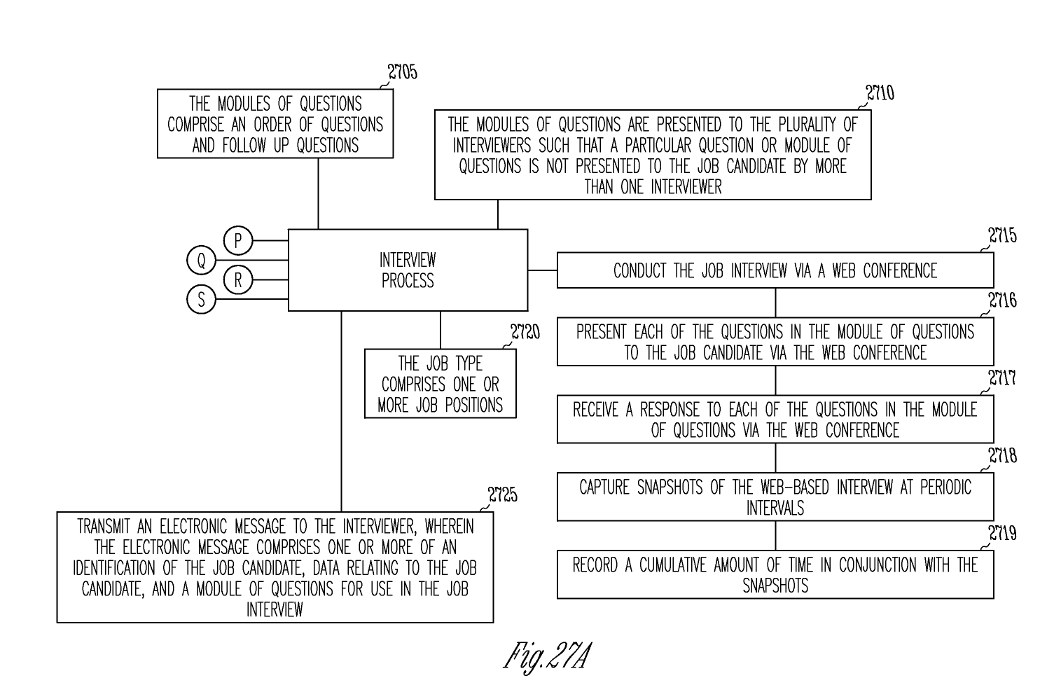

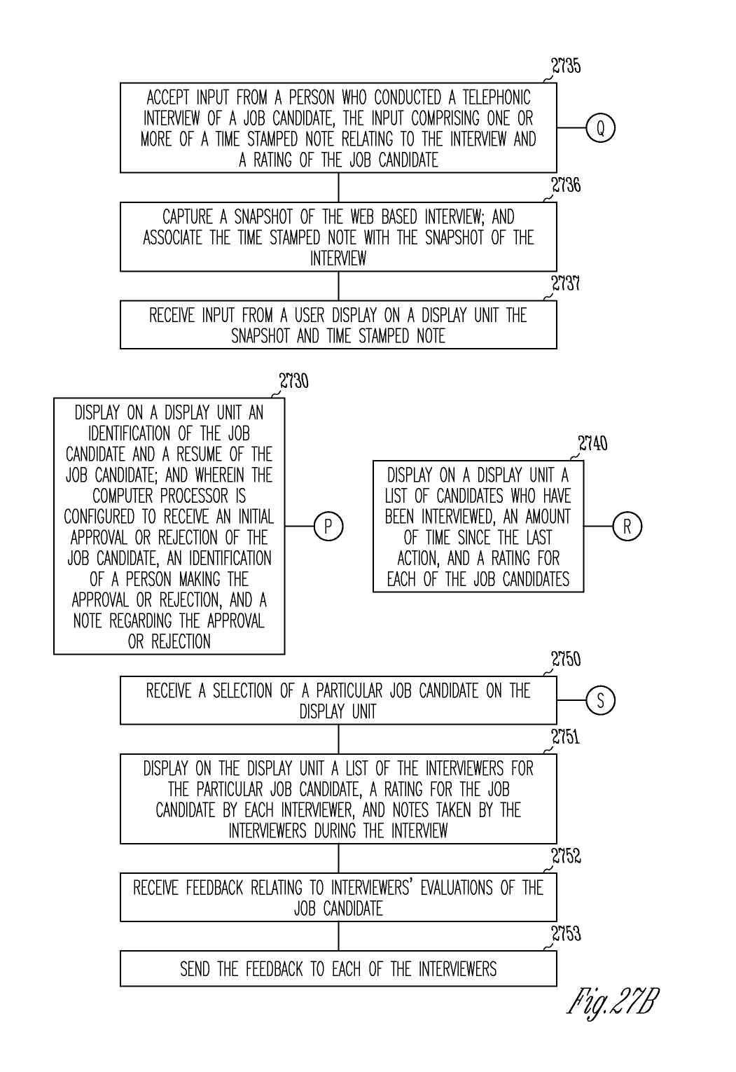

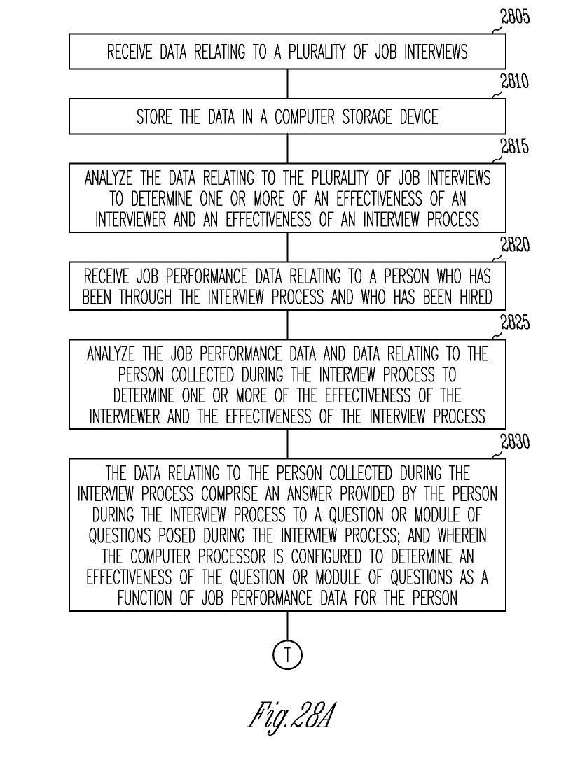

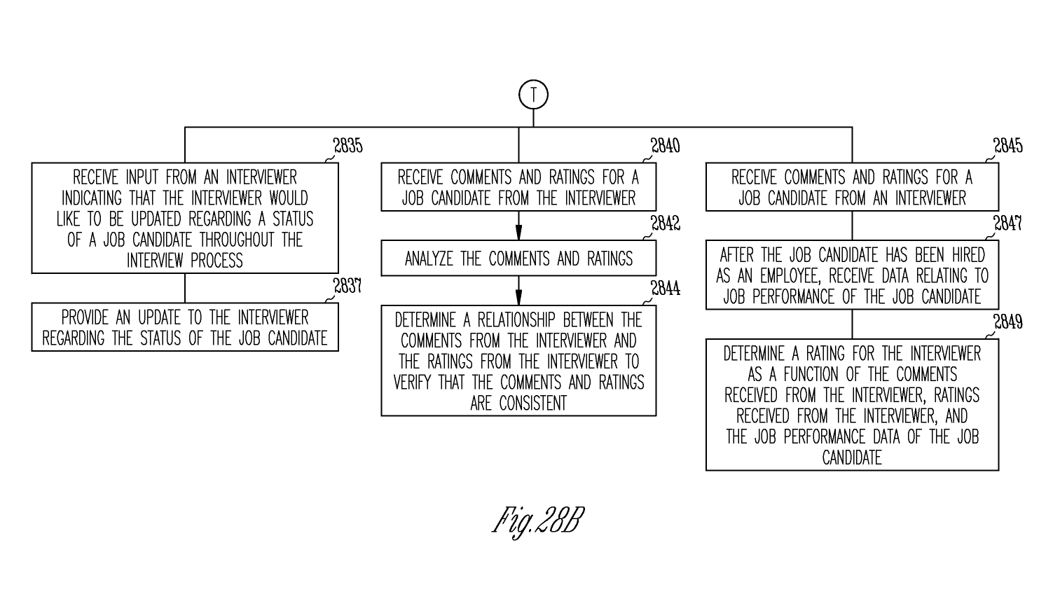

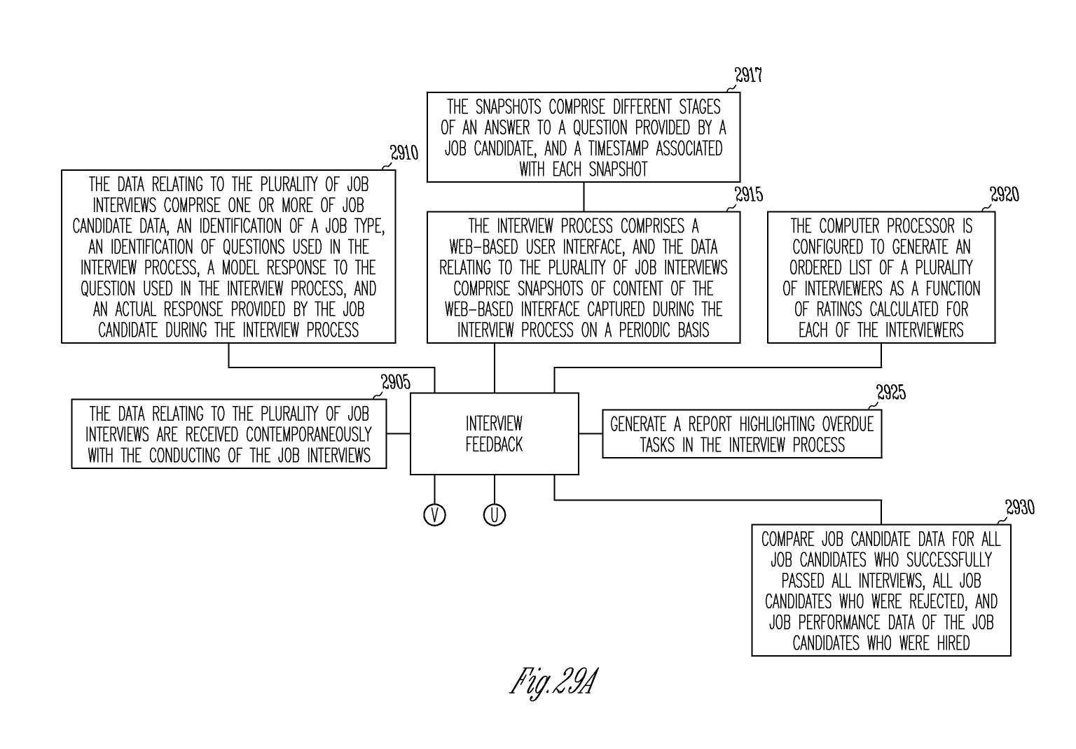

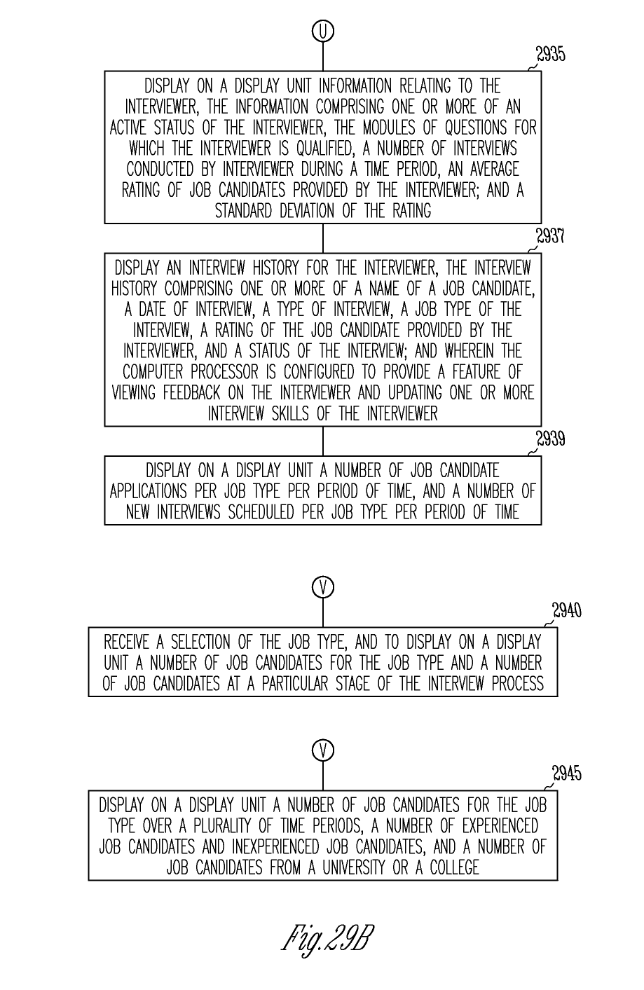

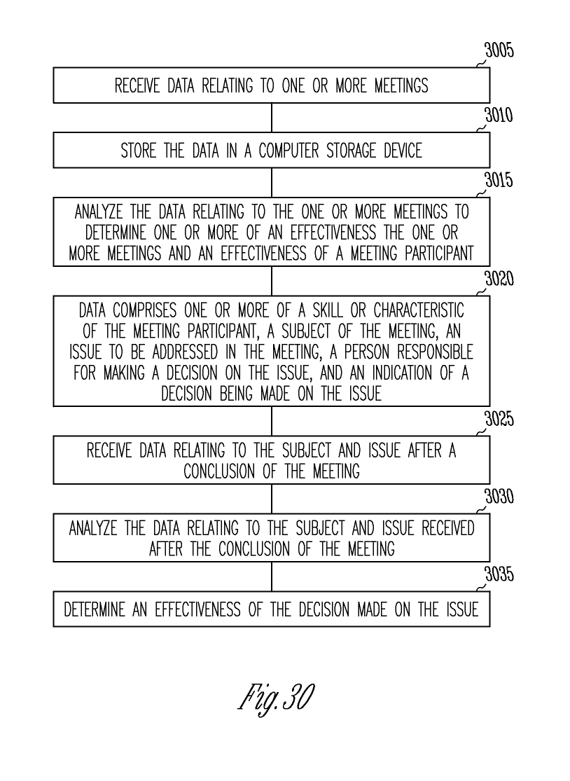

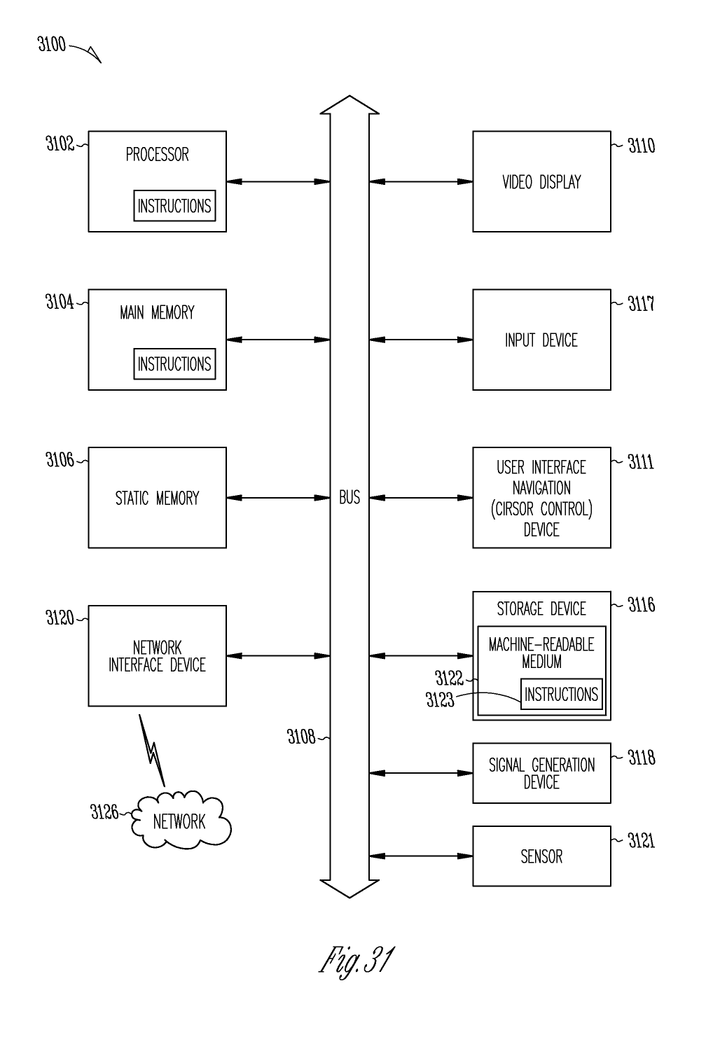

FIG. 3 is an example of a candidate informational user interface 300 that displays details about a particular job candidate. For example, section 310 displays the name of the job candidate, the job track, the recruiter's name, and an email address and contact phone number for the job candidate. Section 320 displays the resume of the job candidate. Section 320 includes tabs that permit one to view a candidate's history, notes associated with the candidate, and further permits coupling to other sites or services such as social networking sites. Section 330 displays the status of the job candidate, and includes a button or icon for the acceptance or rejection of the job candidate. Section 340 includes recruiter notes about the job candidate, an additional status of the job candidate, and a button or icon that allows any employee to “follow” this job candidate. When a recruiter or other user follows a job candidate, that recruiter or user can examine the status of and/or receive updates about the status of the job candidate throughout the job interview and hiring process.

FIG. 4 is an example of a user interface 400 that permits a recruiter to provide feedback on a job candidate. The user interface 400 is particularly suited for use by a front end recruiter after an initial telephonic or web-based interview. As illustrated in FIG. 4, the recruiter can enter notes about the interview of the job candidate, provide a grade and hiring recommendation for the candidate, approve the job candidate for a further phone interview, and/or reject the candidate.

FIG. 5 is an example of a recruiter user interface 500 illustrating job candidates and the recruiting coordinators to whom the job candidates can be assigned and/or have been assigned. Specifically, at 510, the recruiting coordinator supervisor can display a drop down menu of the available recruiting coordinators, and then select from the drop down list the recruiter coordinator to assign to the job candidate. The drop down list of recruiting coordinators indicates in parenthesis the number of job candidates that coordinator is presently handling. A front end recruiter can use this information in his or her determination of which recruiting coordinator to assign to a job candidate. Where a specific recruiting coordinator has previously handled scheduling of a candidate, the drop down list is pre-filled to select his or her name. This allows the supervisor to keep the same recruiting coordinator for a given candidate when possible.

FIG. 6 is an example of a recruiter user interface 600 that is used to schedule phone screen interviews and onsite interviews for job candidates. As illustrated in FIG. 6, a list of job candidates who have been approved for an onsite interview after going through a telephonic or other initial interview are listed on the user interface 600. A recruiting coordinator or other user chooses to schedule an onsite interview for a job candidate at 610, and at this point the system commences the generation of an interview schedule for the job candidate. As noted on FIG. 23 at 2325, the generated interview schedule includes the one or more persons who were selected to interview the job candidate, time periods for each of the different interviewers, and the location(s) of the interviews.

FIG. 7 is another example of a recruiter user interface 700 that is used to schedule onsite interviews for job candidates. As illustrated in FIG. 7, which is similar to FIG. 3, section 710 displays the name of the job candidate, the job track, the recruiter's name, and an email address and contact phone number for the job candidate. Section 720 displays the resume of the job candidate. Section 720 includes tabs that permit one to view a candidate's history, notes associated with the candidate, and further permits coupling to other sites or services such as social networking sites. Section 730 displays the status of the job candidate, that is, that the job candidate is ready for the scheduling of an onsite interview, and a button and/or icon that permits the initiation of the interview scheduling. Section 740 includes recruiter notes about the job candidate and the upcoming interview, and a button or icon that allows any employee to “follow” this job candidate. As noted before, when a recruiter or other user follows a job candidate, that recruiter or user can examine the status of and/or receive updates about the status of the job candidate.

FIG. 8 is an example of a user interface 800 that displays an interview schedule for a job candidate and permits a recruiter or other user to select locations for the interviews. As illustrated in FIG. 8, the user interface 800 displays the name of the job candidate, the interviewers and their associated time slots, and the module or subject matter to be addressed during the interview time slot. As indicated above, the module can include predefined questions or problems to present to the job candidate. The drop down menu at 810 permits the recruiting coordinator or other user to select a location for each interview segment. In another embodiment, the system accesses a database that includes meeting rooms and their availability, and automatically schedules the interview segments into one or more different meeting rooms. Specifically, as shown in FIG. 23, at 2330, the system stores in a location computer storage device data relating to one or more locations at which the interview can be conducted, and at 2335, the system selects one or more locations for the interview.

FIG. 9 is an example of a recruiter user interface 900 that displays details of an interview schedule for a particular job candidate. As can be seen in FIG. 9, the interface 900 displays at 910 the interviewee's name, the names of the interviewers and their associated time slots, the subject matter of the interview segment and/or the module of questions that the interviewer can use. The user interface 900 also permits the recruiting coordinator or other user to perform several functions. At 920, if the interview schedule is acceptable to the recruiting coordinator, the recruiting coordinator can select the “Confirm Locations and Send Invites” icon, and an electronic calendar invitation will be sent to all the interviewers informing them of the time and place of their interview segments. The icon at 920 also accesses a database to secure the locations of the interviews. At 930, the recruiting coordinator is permitted to change the location of one or more interview segments via the “Replace Rooms” icon. At 940, the “Notify All” icon permits any user to send an electronic message to all of the interviewers. At 950, the recruiting coordinator can switch two interview slots by selecting the “Swap Slots” icon.

FIG. 10 is an example of an interviewer user interface 1000 that displays specifics of an upcoming interview. For example, FIG. 10 illustrates that the interviewer user interface 1000 displays at 1010 the name of the job candidate, the location of the interview, the time of the interview, the type of interview (such as telephonic or onsite), an identification of a module of questions for the interviewer, and a co-interviewer if there is one. The interface 1000 also permits the interviewer to download the resume of the job candidate at 1020. If the interviewer cannot make the interview, he or she can cancel his or her participation in the interview using the “Can't Make It” icon at 1040. The interviewer can also select the questions or problems the interviewer would like to use in the interview using the “Select Your Questions” icon at 1030. This functionality can be invoked either before the interview or during the interview. Additionally, at 1050, the interviewer can jump to a page where they can enter feedback about the candidate (skipping the in-interview note taking part). This functionality will be addressed in more detail below.

FIGS. 23A and 23B illustrate several additional functionalities of a computer-based interview scheduling system. At 2340, the system receives from each person who was invited to participate in interviewing a particular job candidate an indication of whether the person will indeed participate in the interview. At 2345, the system receives from a particular interviewer a subsequent indication that they will have to cancel his or her participation in the interview. (FIG. 10, No. 1040). In response to the cancellation, the system at 2350 generates a list of substitute persons for the interview. This list can be generated as a function of the modules of questions associated with the substitute persons, so that a proper person with the proper credentials for conducting the specific interview is selected, and further generated as a function of the calendar data for the substitute persons, so that a person is invited who is available for the time slot of the interview. At 2355, the system then receives a selection from the recruiting coordinator of an alternate person for the interview. In an embodiment, if an interviewer cancels an interview within a certain time before the interview (e.g., within 24 hours of the interview), then the interviewer is expected to find a replacement. If the interviewer cancels an interview outside of that time period, then the recruiting coordinator can find and schedule a replacement using an interface such as the interface 900 in FIG. 9.

At 2360, the system generates a list of job candidates that are scheduled for upcoming job interviews. See e.g., FIG. 5. At 2365, the system receives a selection of a particular job candidate from the list of job candidates, and displays the interview schedule of the selected job candidate. These functionalities are further illustrated in FIGS. 6, 7, 8, and 9 as disclosed above.

FIGS. 24A, 24B, 24C, 24D, and 24E are diagrams illustrating features of the system and process 2300 for scheduling interviews for job candidates. As referred to above, and as illustrated at 2405, the interview schedule generated by the system can include an initial screening telephonic or web-based interview, and a subsequent in-person or web-based follow up interview. The system can further organize job candidates at 2406 into different categories including awaiting resume review, scheduled for the initial screening interview, and scheduled for the subsequent follow up interview. See e.g., FIG. 2. Additionally, at 2407, the system can organize job candidates into the job type for which the job candidate is seeking employment (or the job type that is being offered by the employer), and the experience level of the job candidate. At 2408, the system further can accept input to assign to a recruiting coordinator a job candidate who has been selected for an interview; and to display on a display unit one or more of an indication of an identification of the candidate selected for the interview, an amount of time since a last action for the candidate selected for the interview, a job type for the candidate selected for the interview, an interview type for the candidate selected for the interview, and an identification of the recruiting coordinator. See e.g., FIG. 5. At 2409, the system further can display on a display unit for the recruiting coordinator one or more candidates to be scheduled for an interview; and to accept an input from the recruiting coordinator signalling the computer processor to automatically generate the interview schedule. See e.g., FIGS. 6 and 7.

As illustrated at 2410, the system can display on a display unit a plurality of job candidates and a status of each of the plurality of job candidates. See e.g., FIG. 1.

As illustrated at 2412, an interviewer can set up personal preferences that he or she may have relating to being selected as an interviewer. These preferences are then considered by the system or recruiting coordinator when interview slots are set up for a job candidate. A user interface 2200 wherein an interviewer can set up such personal preferences is illustrated in FIG. 22. As can be seen in FIG. 22, the user interface 2200 includes a drop down menu 2210 where an interviewer indicates the time zone in which he or she is located. Drop down menus 2220, 2230 permit an interviewer to select when he or she generally prefers to participate in interviews for initial phone interviews and onsite interviews respectively. Checkboxes 2240 permit the interviewer to indicate the days of the week that he or she prefers to participate in interviews, and checkbox 2250 permits the interviewer to select a preferred time buffer between interviews and/or other meetings. In addition to these interviewer defined preferences, as illustrated at 2413, the system can select an interviewer as a function of a number of interviews previously scheduled for the particular person during a particular time period. At 2414, this time period can include a period of time before the interview of the job candidate and a period of time after the interview of the job candidate. The preferences selected by an interviewer via an interface such as user interface 2200 are stored in an interview preference profile. FIG. 22 is only an example interface with example preferences, and other preferences could be added such as an interviewer indicating that he or she would not like to participate in interviews during the month of December.

As illustrated at 2415, the system includes a feature wherein it transmits an electronic message to the one or more persons that have been selected to interview a job candidate. The electronic message can include for example an identification of the job candidate, data relating to the job candidate, a date and time for the interview, and a location for the interview. In another embodiment, as illustrated at 2416, the system includes a feature wherein it transmits the electronic message on a periodic basis to the one or more persons that have been selected to interview the job candidate. Such periodic messages serve as a reminder to each of the persons that were selected to interview the job candidate of an upcoming event relating to the interview (such as the interview itself) or an outstanding task relating to the interview (such as a rating of the job candidate by the interviewer).

Several features of an embodiment relate to the years of experience that an interviewer has in a particular job or technology, and/or the number of years that an interviewer has in interviewing in that particular technology or using a particular module of questions. That is, interviewers can be classified as expert interviewers or apprentice interviewers for a particular technology, job type, or module of questions. For example, at 2420, the system can be configured to associate a particular interviewer with one or more modules of questions as a function of a number of years of work experience in a particular job type, a number of years of training in the particular job type, or a number of years of education in the particular job type. The system could also accept input from an administrator regarding such classifications for interviewers. These classification or qualification levels can then be used by the system or a recruiting coordinator in the selection of persons to interview a job candidate, as indicated at 2421. For example, the system can be configured, or the recruiting coordinator can determine, that at least two expert interviewers should be selected to interview a particular job candidate. In this manner, the system or recruiting coordinator can select the interviewers such that at least a minimum number of interviewers is selected to interview the job candidate, and such that at least a minimum number of interviewers at a particular interview qualification level or an experience level is selected to interview the job candidate. Additionally, as indicated at 2422, the system or recruiting coordinator can then select the interviewers such that an experience level of each of the interviewers is greater than the job candidate. Alternatively, the system or recruiting coordinator can select the interviewers such that the experience level of each interviewer is within a range of the job candidate, such as a range of plus or minus two years of experience.

As indicated above, the assignment of classification or qualification levels can be based on the number of times that a particular interviewer has conducted interviews using a particular module of questions, as indicated as 2425. In another embodiment, as indicated as 2426, the system can automatically associate the qualification level with the particular interviewer as a function of the number of interviews accepted by the interviewer, the number of interviews conducted by the interviewer, interview feedback provided by the interviewer, and a correlation between ratings of job candidates provided by the particular person and decisions by an employer as to whether they would like to hire the job candidates. Regarding the correlation for example, if the job candidates that were highly rated by the interviewer were also candidates that the employer indicated that they would like to hire, then that will likely result in a higher qualification level for the interviewer.

As indicated at 2430, in a similar feature, the system can automatically associate a qualification level with a particular interviewer as a function of a number of interviews conducted by the interviewer (as compared to other interviewers), a ratio of interviews accepted by the interviewer and interviews attended by the interviewer, a ratio of interviews accepted by the interviewer and interviews for which the interviewer provided feedback in a timely manner, ratings provided by a hiring committee on the feedback of the interviewer, and a correlation of the particular person's past ratings of job candidates and whether the employer wanted to hire the job candidates.

At 2435, an interviewer computer database includes data relating to a particular area of a job type, and the persons selected to interview the job candidate are selected as a function of the particular area. At 2437, particular area includes a specific module of questions or a particular type of questions.

In an embodiment, as indicated at 2440, the interview scheduling system can be tied to a social networking service. The interview scheduling system can use the social networking service such that the system selects the interviewers as a function of a connection in the social network between the interviewers and the job candidate, a common school as indicated in the social network, and a similar skill set as indicated in the social network. At 2442, the system can request and receive from the interviewers input relating to the job candidate. The system request is a function of a connection between interviewers and the job candidate in the social network.

In an embodiment, as indicated at 2445, the job interview system includes a fairness algorithm. The fairness algorithm relates to spreading the burden of conducting interviews over as many different people as possible. Specifically, the fairness algorithm selects interviewers such that each of the interviewers is selected for an approximately equal number of interviews over a time period, or a particular interviewer is selected for an interview based on a fewer number of interviews accepted by the particular interviewer as compared to the other interviewers. In an alternative embodiment, After the system identifies a set of interviewers who haven't taken too many recent interviews, the system selects from that set the interviewers who have been scheduled for a given interview module (i.e., set of questions for a particular job track) less frequently than others in the set. For example, if Abe, Betty, and Carla all have a current interview load of two interviews, the system is scheduling a particular module, and if Abe and Betty both have interviewed with that particular module more times than Carla has in the past, then the system will select Carla to interview this particular module at this particular time. If Betty and Carla have both done it the same number of times, and fewer times than Abe, then the system will select randomly between Betty and Carla.

At 2450, the system includes data relating to a job, and that data includes one or more job positions. At 2455, when the system schedules interviewers to interview a job candidate, it automatically updates the calendar database of the selected interviewers. At 2460, the system permits a recruiting coordinator or other administrator to alter the interview schedule. At 2465, the system transmits the interview schedule to a mobile device for the job candidate and/or mobiles devices for the interviewers of the job candidate.

FIG. 25 is a flow chart of an example system and process to schedule a meeting and select people to invite to the meeting. At 2505, the system stores in a database data relating to a plurality of persons. The plurality of persons is normally employed at the same business organization, but the plurality can also be spread across more than one business organization or not be associated with a business organization at all. The data includes one or more of skills, characteristics, and attributes for each of the persons. At 2510, calendar data relating to each of the plurality of persons is stored in a database. At 2515, data is received into the system relating to a subject for a meeting. This meeting subject is normally entered by the person who initiates or organizes the meeting. At 2520, the system selects for the meeting organizer one or more persons to invite to the meeting. The system makes this selection based on the skills, characteristics, or attributes associated with each of the one or more persons. For example, if the meeting organizer wants to organize a meeting in which a new product line of mobile device will be discussed, the meeting organizer will enter the meeting subject of “Mobile Devices” into the system, and the system will identify the persons who are knowledgeable in that technology area. In another embodiment, the system presents to a meeting organizer a list of meeting participant attributes (such as via a drop down list or a checkbox list) from which the meeting organizer can choose. The attributes can include technical skills, schools attended, companies worked for, and any other attribute. The system will then identify potential meeting participants based on the meeting organizer's explicit selections. At 2525, the system generates an invitation to the meeting that includes the persons identified as having some knowledge of the subject matter of the meeting. The invitations are further based on the calendar data for the persons who have knowledge of the subject matter of the meeting. In another embodiment, the system does not immediately generate an invitation to all persons that have knowledge of the subject matter of the meeting, but rather generates a list of the persons, and the meeting organizer can then select whom to send meeting invitations. At 2530, the system also generates an invitation to the meeting for persons who were not selected as a function of the skills, characteristics, or attributes. This permits a meeting organizer to invite people to the meeting who may not have the particular knowledge of the subject matter of the meeting, but whom the meeting organizer would still like to invite for one reason or another.

FIG. 26 is a flow chart of an example process 2600 for conducting an interview of a job candidate using a particular module of questions. At 2605, one or more modules of questions are stored into a computer storage device for use in connection with an interview of a job candidate for a particular type of job. At 2610, data associating each of a plurality of interviewers with a particular module of questions that an interviewer is trained in or qualified to use in an interview are stored in a computer storage device. At 2615, one or more modules of questions are provided to one or more interviewers for use in the interview of the job candidate. And at 2620, responses of the job candidate during the interview and comments and ratings of the interviewer during the interview are captured and stored in a computer storage device.

FIG. 11 is an example user interface 1100 that can be used by an interviewer during the interview of a job candidate. The interface 1100 permits an interviewer to select listed modules of questions, such as software development questions relating to Insertion into a Sorted Range 1120 and Reverse Polish Notation 1130. Such listed questions are most likely modules with which the particular interviewer is qualified to work with, and are the reason why the interviewer was selected to interview this particular job candidate using this particular module of questions. An interviewer also is provided the ability to select another module of questions for use during the interview at 1140. This ability provides flexibility to the interviewer and such questions can be used as replacements and/or follow ups during the interview. The user interface 1100 further permits the interviewer to record notes at 1110 during the interview.

FIG. 12 is another example user interface 1200 that can be used by an interviewer during the interview of a job candidate. The user interface includes a box 1230 that displays the notes that the interviewer recorded during the interview. The interviewer can then easily review these notes when he or she provides feedback on the interview to the hiring committee. This enables an interviewer to conduct the interview, and then provide the rating at a later time, which in the business world is normally the case. Each of the notes includes a timestamp, which further can aid the interviewer in preparing the rating of the job candidate. Box 1210 is where the interviewer can provide his or her formal comments and feedback on the interview and the job candidate. In an embodiment, the comments can be entered under headings of Good, Fair, Poor, and Overall. This delineation can help the interviewer organize his or her comments, the hiring committee in reviewing the comments, and the system in comparing an interviewer's comments and ratings to see if they are consistent. At 1220, the interviewer can enter an overall rating for the candidate, and then send the rating and comments to the hiring committee via the Send Feedback button 1240. FIG. 13 illustrates a feedback user interface 1300 with interviewer comments entered in box 1210 in association with the Fair heading.

In an embodiment, model answers to the model questions can be stored by the system, and displayed to the interviewer either during or after the interview of the job candidate. For example, referring to FIG. 11, if the interviewer selected the module of questions relating to the Reverse Polish Notation 1130, the system stores and the interviewer can review answers to the Reverse Polish Notation questions and problems that were presented to the job candidate during the job interview. As noted, if there are more than one model answer to a particular question, which in not atypical in certain fields such as the software development arts, the system can store a plurality of model answers to the questions in the module, and the interviewer can review one or more of the model answers to determine if a job candidate came up with one or more such model answers. While it has been alluded to that such modules of questions and such model answers can relate to the software development arts, the embodiments of this disclosure are not limited to the software development arts. As another example, the module of questions can relate to a particular medical condition, and the model answers associated with such modules of questions can be model medical diagnoses to such questions, situations, or lists of symptoms.

Other features can be built into the modules of questions as illustrated in FIGS. 27A and 27B. Block 2705 illustrates that the modules of questions can include an order of questions and follow up questions. This feature assists an interviewer in presenting to a job candidate a most efficient way of presenting the questions and follow up questions to a job candidate. Block 2710 illustrates that modules of questions are presented to several interviewers such that a particular question or module of questions is not presented to the job candidate by more than one interviewer. This feature prevents redundancy in interviews, which could quite possibly to occur when there are multiple interviewers interviewing a particular job candidate.

Block 2715 indicates that the interview can be conducted via a web conference. In particular, block 2716 illustrates that each of the questions in the module of questions is presented to the job candidate via the web conference, and block 2717 illustrates that a response to each of the questions in the module of questions is received by the interviewer via the web conference. Block 2718 illustrates that the system can be configured to capture snapshots of the web-based interview at periodic intervals, and block 2719 illustrates that the system can be configured to record a cumulative amount of time in conjunction with the snapshots. Blocks 2718 and 2719 permit an interviewer and/or hiring committee to review a job candidates response to a question, and in particular the amount of time it took the job candidate to answer a question or particular sections of a question, snapshots, and evaluate the attractiveness of the candidate. See e.g., FIG. 12, No. 1230.

Block 2720 illustrates that the data relating to the job type comprises one or more job positions. Organizing the job data by job type makes it easier to matchup interviewers with job candidates and job candidates with particular job openings.

Block 2725 illustrates that the system can transmit an electronic message to the interviewer that includes an identification of the job candidate, data relating to the job candidate, and a module of questions for use in the job interview. Block 2730 illustrates that the system can display on a display unit an identification of the job candidate and a resume of the job candidate, and further that the system can receive an initial approval or rejection of the job candidate, an identification of a person making the approval or rejection, and a note regarding the approval or rejection. See e.g., FIG. 3.

At 2735, the system accepts input from a person who conducted a telephonic interview of a job candidate. The input includes a time stamped note relating to the interview and a rating of the job candidate. Additionally, as indicated at 2736, the telephonic interview can include a web-based interview, and the system can capture a snapshot of the web based interview and associate the time stamped note with the snapshot of the interview. Further, as indicated at 2737, the system can receive input from a user, and display on a display unit the snapshot and time stamped note.

At 2740, the system displays on a display unit a list of candidates who have been interviewed, an amount of time since the last action, and a rating for each of the job candidates. For example, FIG. 14 is a user interface 1400 that lists job candidates, an age since the last action on each candidate, and ratings for each of the candidates. FIG. 14 displays an average rating from all of the master interviewers, an average rating for all of the apprentice interviewers, and a total average rating. FIG. 14 further displays the number of master interviewers that reported ratings on the candidate. For example, for job candidate Susan Wu, out of six total apprentice interviewers, three provided ratings and the average of the three ratings was 2.8.

FIG. 15 illustrates a user interface 1500 that includes box 1510 that identifies the job candidate and the front and back end recruiters. Box 1520 lists the people who interviewed this candidate, and the ratings of this candidate provided by those interviewers. Box 1530 displays the interview status of this candidate, and in box 1540, notes, statuses and timelines for interviewers (such as if and when an interviewer modified his or her rating of the job candidate). FIG. 27B further illustrates at 2750 the selection of a particular candidate from a user interface. At 2751, a user interface displays (FIG. 15) a list of the interviewers for the particular job candidate, a rating for the job candidate by each interviewer, and notes taken by the interviewers during the interview. At 2752, the system can receive feedback relating to the interviewer's evaluations of the job candidate, and at 2753, the feedback can be sent to the interviewer. This is further illustrated in the user interface 1500 of FIG. 15, which permits a hiring committee to send feedback to each interviewer on his or her conducting of the interview via the Email Feedback button in Box 1520. An interviewer can review such feedback via user interface 1600 of FIG. 16.

FIGS. 28A and 28B are a flow chart of an example process to determine an effectiveness of an interviewer and an effectiveness of an interview process. At 2805, data relating to a plurality of job interviews is received. The reception and handling of the data can occur before, during, and/or after the interview, and can involve the use of user interfaces such as those illustrated in FIGS. 3, 4, 7, 11, and 12. At 2810, the data is stored in a computer storage device on the system. At 2815, the data relating to the plurality of job interviews is analyzed to determine one or more of an effectiveness of an interviewer and an effectiveness of an interview process.

In an embodiment, the effectiveness of a particular interviewer and/or a particular interview process is determined as follows. At 2820, job performance data relating to a person who has been through the interview process and who has been hired is collected and stored. At 2825, the job performance data and data relating to the person collected during the interview process is analyzed to determine one or more of the effectiveness of the interviewer and the effectiveness of the interview process. The data that is collected and stored can include such information as punctuality in finishing projects; the quality, correctness, and accuracy in the completion of projects; and the ability of the person who was hired to work well with others. For example, if an interviewer gave high ratings to several job candidates, and after being hired, most or a good portion of these job candidates perform well in the job, then that is indicative of the interviewer having the ability to interview job candidates and determine the job candidates who will be good hires and employees. Of course the converse is also true, if the interviewer has given low ratings to several job candidates, but such candidates were hired (because other interviewers gave higher ratings to the job candidates), then that interviewer may not have a keen sense of determining who will make a good hire or employee. Additionally, at 2830, the data relating to the person collected during the interview process includes an answer provided by the person during the interview process to a question or module of questions posed during the interview process, and an effectiveness of the question or module of questions as a function of job performance data for the person is determined. Consequently, in a manner similar to the comparison of the interviewer's ratings and performance of hires, particular interview questions and modules of questions can be analyzed and studied to determine which interview questions or modules of questions can identify persons who will be good hires.

At 2835, input is received from an interviewer indicating that the interviewer would like to be updated regarding a status of a job candidate throughout the interview process. FIG. 15 at 1540 illustrates a user interface having a button wherein an interviewer can input this designation. At 2837, an update is subsequently provided to the interviewer regarding the status of the job candidate. This permits an interviewer who is particularly interested in a job candidate, either for positive or negative reasons (e.g., the interviewer believes that the person will be a good or a bad hire) to follow that candidate throughout the interview process and the ultimate job offer or rejection of the candidate.

At 2840, comments and ratings for a job candidate are received from an interviewer. At 2842, the comments and ratings are analyzed, and at 2844, a relationship between the comments from the interviewer and the ratings from the interviewer is determined to verify that the comments and ratings are consistent. In an embodiment, this can be done by a person in the hiring committee to see if the interviewer's comments and ratings are consistent. That is, to verify that an interviewer provides both positive comments and a high rating, and vice versa. This determination can also be done automatically by the system. For example, using box 1210 in FIG. 12, an interviewer's comments can be entered as Good, Fair, and/or Poor. The system can therefore determine that if the interviewer entered only good comments, that the rating of the job candidate is commensurately good.

In another embodiment, at 2845, comments and ratings for a job candidate are received from an interviewer. Then, at 2847, after the job candidate has been hired as an employee, data relating to the job performance of the job candidate is collected. At 2849, a rating for the interviewer is determined as a function of the comments received from the interviewer, ratings received from the interviewer, and the job performance data of the job candidate. This embodiment or feature provides a relatively direct measurement of the effectiveness of the interviewer.

FIGS. 29A and 29B are a diagram illustrating features of a system and process to determine an effectiveness of an interviewer and an effectiveness of an interview process. At 2905, the data relating the plurality of job interviews are received contemporaneously with the conducting of the job interviews. This feature can be enabled via the user interface 1230 of FIG. 12, which permits a streamlining of the job interview process. At 2910, the data relating to the plurality of job interviews, collected at step 2805 of FIG. 28, include job candidate data, an identification of a job type, an identification of questions used in the interview process, a model response to the question used in the interview process, and/or an actual response provided by the job candidate during the interview process.

At 2915, the interview process uses a web-based user interface. When such a web-based user interface is used, the data relating to the plurality of job interviews can include snapshots of content of the web-based interface captured during the interview process on a periodic basis. At 2917, such snapshots can include different stages of an answer to a question provided by a job candidate and a timestamp associated with each snapshot. This feature is useful when the questions require a multi-step answer, such as a software coding solution to a computer programming problem. This permits a member of the hiring committee or other person to determine if any particular part of the solution took the job candidate an inordinate amount of time to solve or was unusually quickly solved.

At 2920, an ordered list of a plurality of interviewers is generated as a function of ratings calculated by each of the interviewers. This feature permits a determination of whether an interviewer is an easy grader of job candidates or a strict grader of job candidates. At 2925, a report highlighting overdue tasks in the interview process is generated. An example of such a report on a user interface is illustrated in FIG. 21, and can be referred to as a bottleneck report. For example, FIG. 21 shows at 2110 that for the applications engineer job track, 45 candidate applications have been at the state of waiting on a determination of whether the candidates have passed the onsite interview for a period of greater than 1 day. FIG. 21 further illustrates that different thresholds (i.e., different than 1 day) can be applied to the different stages of the process.

At 2930, the feature includes a comparison of job candidate data for all job candidates who successfully passed all interviews, all job candidates who were rejected, and job performance data of the job candidates who were hired. This feature permits a comparison of successful job candidates and candidates who were rejected. Such comparison may permit an identification of distinguishing characteristics of the job candidates, such as a high percentage of successful job candidates who have attended a particular college or university, and a high percentage of unsuccessful candidates who have attended a different college or university.

At 2935, and as further illustrated in FIG. 17, a user interface displays information relating to the interviewer, the information comprising one or more of an active status of the interviewer (1710), the modules of questions for which the interviewer is qualified (1720), a number of interviews conducted by the interviewer during a time period (1730), an average rating of job candidates provided by the interviewer (1730); and a standard deviation of the rating (1730). The number in the ribbon icon in section 1710 of the user interface indicates the number of special kudos the interviewer has received from the hiring committee. At 2937, a user interface is configured to display an interview history for the interviewer, the interview history comprising one or more of a name of a job candidate, a date of interview, a type of interview, a job type of the interview, a rating of the job candidate provided by the interviewer, and a status of the interview. An example of user interface that can display such information is illustrated in FIGS. 18 at 1810 and 1820.

FIG. 17A is a user interface 1700A illustrating the interviewers who are subordinate to a particular manager or other leader. Specifically, at 1710A, a drop down menu permits the selection of a manager or other leader. After the selection of the manager via the drop down menu 1710A, the manager's interview team statistics are displayed. At 1720A, the interface displays the number of interviews performed by the manager's team (for the time period as selected at 1715A), and the average number of interviews per person on the manager's team. At 1730A, the interface displays the number of times that a person on the manager's team did not show up for an interview, and the average of such no-shows per person. At 1740A, the interface displays the number of persons on the manager's team who have never participated in an interview. At 1750A and 1755A respectively, the user interface displays the top interviewers and the bottom interviewers. As can be seen from the interface, the top and bottom interviewers are not necessarily based on the number of interviews conducted by a person, but also on other factors as disclosed throughout the specification (e.g., the timeliness of an interviewer's providing of comments and a rating after an interview). The interface further displays other statistics such as the number and percentage of master and apprentice interviewers on the manager's team, and the team members who have no interview skills.

At 2939, a user interface is configured to display a number of job candidate applications per job type per period of time, and a number of new interviews scheduled per job type per period of time. An example of such a user interface is illustrated in FIG. 19 at 1910, 1920. At 2940, a user interface receives a selection of a job type, and displays a number of job candidates for the job type and a number of job candidates at a particular stage of the interview process. An example of such a user interface is illustrated in FIGS. 20 at 2010 and 2020. At 2945, a user interface displays a number of job candidates for the job type over a plurality of time periods, a number of experienced job candidates and inexperienced job candidates, and a number of job candidates from a university or a college.

FIG. 30 is a flow chart of an example process to determine an effectiveness of a meeting and an effectiveness of a meeting participant. At 3005, data relating to one or more meetings are collected. At 3010, the data is stored in a computer storage device. At 3015, the data relating to the one or more meetings is analyzed to determine an effectiveness of the meetings and/or an effectiveness of a meeting participant. At 3020, the data include a skill or characteristic of the meeting participant, a subject of the meeting, an issue to be addressed in the meeting, a person responsible for making a decision on the issue, and/or an indication of a decision being made on the issue.

At 3025, data relating to the subject and issue are collected after a conclusion of the meeting. At 3030, the data relating to the subject and issue received after the conclusion of the meeting are analyzed. At 3035, an effectiveness of the decision made on the issue is determined. For example, if the subject of the meeting related to increasing sales by making more sales calls, and a salesperson with 30 years of experience was invited to and attended the meeting, and the salesperson suggested and it was agreed to make sales calls on Tuesday mornings, and that lead to a successful increase in successful sales calls, then the meeting would be deemed effective.

FIG. 31 is a block diagram of a machine in the form of a computer system within which a set of instructions, for causing the machine to perform any one or more of the methodologies discussed herein, may be executed. In alternative embodiments, the machine operates as a standalone device or may be connected (e.g., networked) to other machines. In a networked deployment, the machine may operate in the capacity of a server or a client machine in a client-server network environment, or as a peer machine in peer-to-peer (or distributed) network environment. In a preferred embodiment, the machine will be a server computer, however, in alternative embodiments, the machine may be a personal computer (PC), a tablet PC, a set-top box (STB), a Personal Digital Assistant (PDA), a mobile telephone, a web appliance, a network router, switch or bridge, or any machine capable of executing instructions (sequential or otherwise) that specify actions to be taken by that machine. Further, while only a single machine is illustrated, the term “machine” shall also be taken to include any collection of machines that individually or jointly execute a set (or multiple sets) of instructions to perform any one or more of the methodologies discussed herein.

The example computer system 3100 includes a processor 3102 (e.g., a central processing unit (CPU), a graphics processing unit (GPU) or both), a main memory 3101 and a static memory 3106, which communicate with each other via a bus 3108. The computer system 3100 may further include a display unit 3110, an alphanumeric input device 3117 (e.g., a keyboard), and a user interface (UI) navigation device 3111 (e.g., a mouse). In one embodiment, the display, input device and cursor control device are a touch screen display. The computer system 3100 may additionally include a storage device 3116 (e.g., drive unit), a signal generation device 3118 (e.g., a speaker), a network interface device 3120, and one or more sensors 3121, such as a global positioning system sensor, compass, accelerometer, or other sensor.

The drive unit 3116 includes a machine-readable medium 3122 on which is stored one or more sets of instructions and data structures (e.g., software 3123) embodying or utilized by any one or more of the methodologies or functions described herein. The software 3123 may also reside, completely or at least partially, within the main memory 3101 and/or within the processor 3102 during execution thereof by the computer system 3100, the main memory 3101 and the processor 3102 also constituting machine-readable media.

While the machine-readable medium 3122 is illustrated in an example embodiment to be a single medium, the term “machine-readable medium” may include a single medium or multiple media (e.g., a centralized or distributed database, and/or associated caches and servers) that store the one or more instructions. The term “machine-readable medium” shall also be taken to include any tangible medium that is capable of storing, encoding or carrying instructions for execution by the machine and that cause the machine to perform any one or more of the methodologies of the present invention, or that is capable of storing, encoding or carrying data structures utilized by or associated with such instructions. The term “machine-readable medium” shall accordingly be taken to include, but not be limited to, solid-state memories, and optical and magnetic media. Specific examples of machine-readable media include non-volatile memory, including by way of example semiconductor memory devices, e.g., EPROM, EEPROM, and flash memory devices; magnetic disks such as internal hard disks and removable disks; magneto-optical disks; and CD-ROM and DVD-ROM disks.

The software 3123 may further be transmitted or received over a communications network 3126 using a transmission medium via the network interface device 3120 utilizing any one of a number of well-known transfer protocols (e.g., HTTP). Examples of communication networks include a local area network (“LAN”), a wide area network (“WAN”), the Internet, mobile telephone networks, Plain Old Telephone (POTS) networks, and wireless data networks (e.g., Wi-Fi® and WiMax® networks). The term “transmission medium” shall be taken to include any intangible medium that is capable of storing, encoding or carrying instructions for execution by the machine, and includes digital or analog communications signals or other intangible medium to facilitate communication of such software.

Although an embodiment has been described with reference to specific example embodiments, it will be evident that various modifications and changes may be made to these embodiments without departing from the broader spirit and scope of the invention. Accordingly, the specification and drawings are to be regarded in an illustrative rather than a restrictive sense. The accompanying drawings that form a part hereof, show by way of illustration, and not of limitation, specific embodiments in which the subject matter may be practiced. The embodiments illustrated are described in sufficient detail to enable those skilled in the art to practice the teachings disclosed herein. Other embodiments may be utilized and derived therefrom, such that structural and logical substitutions and changes may be made without departing from the scope of this disclosure. This Detailed Description, therefore, is not to be taken in a limiting sense, and the scope of various embodiments is defined only by the appended claims, along with the full range of equivalents to which such claims are entitled.

The Abstract is provided to comply with 37 C.F.R. §1.72(b) and will allow the reader to quickly ascertain the nature and gist of the technical disclosure. It is submitted with the understanding that it will not be used to interpret or limit the scope or meaning of the claims.

1. A system comprising:
a computer processor configured to:
store in an interviewer computer storage device data relating to a plurality of persons, the data including an association between each of the plurality of persons and a module of questions, the module of questions relating to one or more job types for which each person is qualified to interview a job candidate;
store in a calendar computer storage device calendar data relating to each of the plurality of persons;
receive into the computer processor data relating to the job candidate, the data relating to the job candidate comprising an education history, an employment history, and a job type for which an employer is considering the job candidate;
select from the interviewer computer storage device one or more persons to interview the job candidate as a function of the module of questions associated with each of the one or more persons and the job type for which the employer is considering the job candidate; and
generate an interview schedule for the job candidate, wherein the interview schedule includes the one or more persons selected to interview the job candidate, and wherein the interview schedule is generated as a function of the calendar data for the one or more persons selected to interview the job candidate.

2. The system of claim 1, wherein the interviewer computer storage device comprises an interview preference profile for each person, and the interview schedule is generated as a function of the interview preference profile for each person.

3. The system of claim 1, wherein the computer processor is configured to:
store in a location computer storage device data relating to one or more locations at which the interview can be conducted; and
select one or more locations for the interview.

4. The system of claim 1, wherein the data relating to the job type comprises one or more job positions.

5. The system of claim 1, wherein the computer processor is configured to transmit an electronic message to the one or more persons selected to interview the job candidate; and wherein the electronic message comprises one or more of an identification of the job candidate, data relating to the job candidate, a date and time for the interview, and a location for the interview.

6. The system of claim 5, wherein the computer processor is configured to transmit the electronic message on a periodic basis to the one or more persons selected to interview the job candidate; the electronic message comprising a reminder to each of the one or more persons selected to interview the job candidate of an upcoming event relating to the interview or an outstanding task relating to the interview.

7. The system of claim 1, wherein the computer processor is configured to update the calendar database as a function of the one or more persons selected to interview the job candidate.

8. The system of claim 1, wherein a particular person is associated with one or more modules of questions as a function of a number of years of work experience in the job type, a number of years of training in the job type, or a number of years of education in the job type.

9. The system of claim 1, wherein the computer processor is configured to select a particular person to interview the job candidate as a function of a number of interviews previously scheduled for the particular person during a particular time period.

10. The system of claim 9, wherein the particular time period includes a period of time before the interview of the job candidate and a period of time after the interview of the job candidate.

11. The system of claim 1, wherein the computer processor is configured to use one or more qualification levels to select a person to interview the job candidate (apprentice and master).

12. The system of claim 11, wherein the computer processor is configured to automatically associate a qualification level with a particular person as a function of a number of interviews conducted by the particular person (as compared to other interviewers), a ratio of interviews accepted by the particular person and interviews attended by the particular person, a ratio of interviews accepted by the particular person and interviews for which the particular person provided feedback, ratings provided by a hiring committee on the feedback of the particular person, and a correlation of the particular person's past ratings of job candidates and whether the employer wanted to hire the job candidates.

13. The system of claim 1, comprising a social network computer storage device; wherein the computer processor is configured to select the one or more persons to interview the job candidate as a function of one or more of a connection between the one or more persons and the job candidate in the social network computer storage device, a common school as stored in the social network computer storage device, and a similar skill set as stored in the network computer storage device.

14. The system of claim 1, comprising a social network computer storage device; wherein the computer processor is configured to request and receive from the one or more persons selected to interview the job candidate input relating to the job candidate; wherein the request is a function of a connection between the one or more persons and the job candidate in the social network computer storage device.

15. The system of claim 1, wherein the interviewer computer storage device comprises data relating to a particular area of the job type, and the one or more persons selected to interview the job candidate are selected as a function of the particular area.

16. The system of claim 15, wherein the particular area comprises a specific module of questions or a particular type of questions.

17. The system of claim 1, wherein the computer processor is configured to select the one or more persons to interview the job candidate such that at least a minimum number of persons is selected to interview the job candidate, and such that at least a minimum number of persons at a particular interview qualification level or an experience level is selected to interview the job candidate.

18. The system of claim 1, wherein the computer processor is configured with a fairness algorithm, the fairness algorithm comprising a selection from the plurality of persons such that each of the plurality of persons is selected for an approximately equal number of interviews over a time period or a selection from the plurality of persons such a particular person is selected for an interview based on a fewer number of interviews accepted by the particular person as compared to others of the plurality of persons.

19. The system of claim 1, wherein the computer processor is configured to select the one or more persons to interview the job candidate such that an experience level of each person is greater than the job candidate or the experience level of each person is within a range of the job candidate.

20. The system of claim 1, wherein the computer processor is configured to:
receive an indication from each of the persons that they will participate in the interview of the job candidate;
receive a subsequent indication from a particular person that they will have to cancel his or her participation in the interview;
generate a list of substitute persons for the interview as a function of the modules of questions associated with the substitute persons and the calendar data for the substitute persons; and
receive a selection of an alternate person for the interview.

21. The system of claim 1, wherein the computer processor is configured to receive input from an administrator to alter the interview schedule.

22. The system of claim 1, wherein the computer processor is configured to generate a list of job candidates that are scheduled for upcoming job interviews, to receive a selection of a particular job candidate from the list of job candidates, and to display the interview schedule of the selected job candidate.

23. The system of claim 1, wherein the computer processor is configured to transmit the interview schedule to one or more of a mobile device for the job candidate and mobiles devices for the persons selected to interview the job candidate.

24. The system of claim 1, wherein the computer processor is configured to store a number of times that a particular person has conducted interviews using a particular module of questions.

25. The system of claim 24, wherein the computer processor is configured to identify with a qualification level the particular person qualified to interview the job candidate using the particular module of questions (apprentice and master).

26. The system of claim 25, wherein the computer processor is configured to automatically associate the qualification level with the particular person as a function of one or more of a number of interviews accepted by the particular person, a number of interviews conducted by the particular person, interview feedback provided by the particular person, and a correlation between ratings of job candidates provided by the particular person and decisions by an employer as to whether they would like to hire the job candidates.

27. The system of claim 1, wherein the interview schedule comprises one or more of an initial screening telephonic or web-based interview and a subsequent in-person or web-based follow up interview.

28. The system of claim 27, wherein the computer processor is configured to organize a plurality of job candidates into one or more categories comprising awaiting resume review, scheduled for the initial screening interview, and scheduled for the subsequent follow up interview.

29. The system of claim 1, wherein the computer processor is configured to display on a display unit a plurality of job candidates and a status of each of the plurality of job candidates.

30. The system of claim 27, wherein the computer processor is configured to organize job candidates by one or more of the job type for which the job candidate is seeking employment and an experience level of the job candidate.

31. The system of claim 27, wherein the computer processor is configured to accept input to assign to a recruiting coordinator a job candidate who has been selected for an interview; and to display on a display unit one or more of an indication of an identification of the candidate selected for the interview, an amount of time since a last action for the candidate selected for the interview, a job type for the candidate selected for the interview, an interview type for the candidate selected for the interview, and an identification of the recruiting coordinator.

32. The system of claim 31, wherein the computer processor is configured to display on a display unit for the recruiting coordinator one or more candidates to be scheduled for an interview; and to accept an input from the recruiting coordinator signaling the computer processor to automatically generate the interview schedule.

33. A system comprising:
a computer processor configured to:
store in a computer storage device data relating to a plurality of persons, the data including one or more of skills, characteristics, and attributes for each of the plurality of persons;
store in a calendar computer storage device calendar data relating to each of the plurality of persons;
receive into the computer processor data relating to a meeting subject;
select from the computer storage device one or more persons to invite to a meeting relating to the meeting subject as a function of the skills, characteristics, or attributes associated with each of the one or more persons; and
generate an invitation to the meeting, wherein the invitation includes the one or more persons selected to invite to the meeting, and wherein the invitation is generated as a function of the calendar data for the one or more persons selected to invite to the meeting.

34. The system of claim 33, comprising generating an invitation to the meeting for one or more persons not selected as a function of the skills, characteristics, or attributes.

35. The system of claim 33, wherein the computer processor is configured to:
display meeting subjects, person skills, person characteristics, and person attributes;
receive a selection of meeting subjects, person skills, person characteristics, and person attributes; and
generate an invitation to the meeting for one or more persons as a function of the selection of the meeting subjects, person skills, person characteristics, and person attributes.

36. A system comprising:
a computer processor configured to:
store in a computer storage device data relating to a plurality of persons, the data including one or more of skills, characteristics, and attributes for each of the plurality of persons;
store in a calendar computer storage device calendar data relating to each of the plurality of persons;
select from the computer storage device one or more persons to invite to a meeting as a function of the skills, characteristics, or attributes associated with each of the one or more persons; and
generate an invitation to the meeting, wherein the invitation includes the one or more persons selected to invite to the meeting, and wherein the invitation is generated as a function of the calendar data for the one or more persons selected to invite to the meeting.

37. The system of claim 36, wherein the computer processor is configured to:
display person skills, person characteristics, and person attributes;
receive a selection of person skills, person characteristics, and person attributes; and
generate an invitation to the meeting for one or more persons as a function of the selection of the person skills, person characteristics, and person attributes.
